(19) United States
(12) Patent Application Publication
(10) Pub. No.: US 2026/0270226 A1
(43) Pub. Date: Sep. 10, 2026

(54) MUTUAL BOT IDENTIFICATION USING EMBEDDED SIGNALS

(71) Applicant: Adeia Guides Inc., San Jose, CA (US)

(72) Inventors: Ning Xu, Irvine, CA (US); Jean-Yves Couleaud, Mission Viejo, CA (US); Dhananjay Lal, Englewood, CO (US)

(21) Appl. No.: 19/070,304

(22) Filed: Mar. 4, 2025

(51) Int. Cl. H04L 51/066; H04L 9/40; H04L 51/02; H04L 65/1069

(52) U.S. Cl. CPC H04L 51/066; H04L 51/02; H04L 63/0428; H04L 65/1069

(57) ABSTRACT

A first virtual assistant (VA) communicating via an audio channel for natural language communication, such as voice over internet protocol (VOIP), may discover that it is communicating with another VA, not a human, by embedding a first signal indicating that it is a VA in the audio channel. If it receives a second signal embedded within the audio channel that indicates a second VA then communication may continue using a bot-to-bot communication mode with non-natural-language messages, for more efficient communication. A first VA may encrypt confidential information by first requesting an ephemeral encryption key and using the key it receives to encrypt the confidential communication. A first VA may authenticate a second VA by transmitting a challenge secret and expect to receive a response secret from the second VA.

### BACKGROUND

The present disclosure relates to the bot-to-bot communication and, more particularly, to identifying bot-to-bot audio communication, bot authentication and confidential data encryption.

### SUMMARY

Virtual assistants (VAs) that perform a range of tasks in an autonomous way have been growing in popularity. VAs (sometimes referred to as “bots”) may incorporate chatbot capabilities that simulate human conversation, including voice communication such as voice over IP (VOIP). With the increasing deployment of large language models and other artificial intelligence technologies, VAs have become more sophisticated and provide a range of functions; however, numerous problems remain.

People use VAs for a variety of personal tasks, including making arrangements online or via telephone calls. Similarly, a variety of organizations use VAs to provide customer service functions. For example, a VA may place a telephone call on behalf of a person to make an appointment at a doctor's office, and the call may be answered by a second VA providing customer service functionality on behalf of the doctor's office. The first VA making the phone call may use natural language audio communication to simulate a human (e.g., speaking in English or Spanish) to communicate with the doctor's office and the second VA providing customer service for the doctor's office may similarly use voice communication simulating a human voice to communicate with the customer.

A technological problem that arises when a first VA calls and a second VA answers is that neither the first VA nor the second VA may determine that it is communicating with another VA. Often, because of VAs' human verisimilitude, each VA may continue the voice conversation in the incorrect assumption that it is communicating with a human. Typically, VAs are not trained to try to determine whether or not they are conversing with a human and, in any case, asking questions to try to distinguish a human from a bot would be time consuming and wasteful.

This failure by a VA to recognize that it is conversing with another VA results in wasted time and resources, including, for example in a VoIP context, unnecessary use of network resources. Also, bot-to-bot communication using natural language spoken in a simulated human voice may fail to take advantage of the full audio spectrum range and other communication resources available, for example, in VoIP. Communicating with a human often needs to be at a slower pace than some modes of bot-to-bot communication (e.g., communication between two or more virtual assistants) because conversing with a human must accommodate the capabilities of the human ear and the human brain. In addition, often VAs are trained to incorporate into conversation pleasantries and social conventions, such as greetings and “thank yous” that humans expect.

According to a technological solution provided by an aspect of the disclosure, a VA may insert a signal to identify itself as a VA to the second VA with which it is communicating in the phone call and, if the second VA similarly inserts a signal to identify itself as a VA, then bot-to-bot communication may be initiated to take advantage of more efficient communication capabilities of the medium. For example, the first VA may insert into the audio channel a first signal to humans. The second VA may then recognize the first signal and respond with a second signal, which may or may not be imperceptible to humans. The first signal and/or the second signal may be previously agreed to signal known each of the first VA and the second VA prior to the call to be signals that indicate bot communication. The first signal and/or the second signal may be signals that are shared by a large number of bots to indicate bot communication. The first signal and/or the second signal may be previously known to each of the first VA and the second VA prior to the call to be signals that indicate bot communication. Upon receiving the second signal from the second VA, the first VA may then initiate bot-to-bot communication. The bot-to-bot communication may be voice communication rendered in the baseband domain but at a higher speed, or may be other communication in the data domain, such as binary code embedded in the audio channel, including, for example, packet transmissions. A combination of more than one of such bot-to-bot communication approaches may be used.

The VAs may use various types of signals to identify themselves as VAs in the voice communication. For example, the VA may embed a phase coding signal that alters a phase of the audio signal in the voice communication, may embed a low amplitude wide-band signal into a spectrum of the audio signal, or may use one or more of a variety of other watermarking techniques imperceptible to humans in the voice communication domain or using signals outside the voice communication domain, for example, in a control channel. The second VA may use the same or a different signal to identify itself as a VA to the first VA. In some implementations, the first signal and/or the second signal may be an out-of-band signal transmitted before voice communication is commenced between the bots. For example, a first VA may call a second VA using VoIP and transmit the first signal identifying itself as a VA prior to the second VA answering “Hello.”

According to a further aspect of the disclosure, a VA periodically, or in response to some events, may repeat transmission of the signal and await confirmation from the other VA to continue bot-to-bot communication. In this way, if a human takes over the voice communication (e.g., begins talking, thus causing the VA nearby to stop outputting voice communication), then bot-to-human communication may be initiated (or resumed). For example, one or both of the VAs may periodically transmit the VA identifying signal and, if the receiving VA does not respond with its VA identifying signal, then the system may determine that a human has taken over communication and bot-to-human voice communication may be initiated (or resumed).

In some implementations, if a VA detects that a nearby human on the same end of the line has taken over the voice conversation, the VA may transmit another signal indicating that bot-to-human voice communication is to be initiated. In some implementations, if a first VA detects that a human has interjected natural language human voice communication during the bot-to-bot communication (e.g., a human started speaking in the line instead of, or in addition to the second bot), then the first VA may automatically commence bot-to-human voice communication. Similarly, in such a situation, if the second VA detects that a nearby human on the same end of the line as the second VA has started speaking in the line, then it may switch to human voice communication using natural language. Also, it may notify the other VA to switch away from bot-to-bot communication.

Using bot-to-bot communication may increase efficiency and information throughput and may decrease call length and use of network resources. It may also improve the accuracy of communication by obviating an additional (e.g., manual) task (e.g., a human taking notes), input information manually to some other system, ask for repetition of unfamiliar or technical terms (e.g., ask the doctor's office to repeat the names of medications or medical conditions). Bot-to-bot communication may also improve the sharing of information, because documents, large collections of data (e.g., a travel itinerary from a travel agent), graphics, videos and the like, may be more easily transmitted, received, processed and stored.

Another technological challenge that arises when a VA calls and a second VA answers is keeping personal information secure. Some people prefer a form of assurance that a VA that has access to confidential information of a user, such as personally identifying information (PII), will keep the information safe. Also, various government regulations mandate that confidentiality be maintained for some type of personal information (e.g., medical records, bank records). The Health Insurance Portability and Accountability Act (HIPAA) in the United States, the California Consumer Privacy Act (CCPA), the General Data Protection Regulation (GDPR) in the European Union, and other such laws require compliance with standards for keeping confidential some type of personal information.

According to a technological solution provided by an aspect of the disclosure, when using bot-to-bot communication, a first VA may request an ephemeral encryption key from the second VA with which it is voice communicating. An ephemeral encryption key or ephemeral key, unlike a long-term or static encryption key, may be a cryptographic key that is generated each time or in each session including encryption. It may be short-lived and discarded after use, enhancing security by minimizing exposure to potential compromises. For example, if a bad actor gains access to an ephemeral encryption key, the consequences of such access may be minimized if the ephemeral encryption key will not be used again or will only be used again for a short period of time. An ephemeral encryption key may be used more than once, within a single session if the sender of the key generates only one ephemeral key pair per message and the private key that is used to decrypt the message is combined separately with each recipient's public ephemeral key.

In response, the second VA may then transmit the ephemeral encryption key to the first VA. The ephemeral encryption key may be a public encryption key of the second VA or may be a temporary encryption key to which it retains a secret private key. The first VA may encrypt the confidential information using the ephemeral encryption key and transmit it the encoded information to the second VA.

In some implementations, an audible marker may be embedded in the voice transmission by the transmitting VA prior to the transmission of the ephemeral encryption key. This may signal to the receiving VA that what follows is an ephemeral encryption key. The ephemeral key may be transmitted embedded in the voice communication in manner imperceptible to humans, such as by embedding the ephemeral encryption as part of a phase shifting scheme or may be transmitted in the data domain.

In some embodiments, confidential information may be encoded using analog scrambling such that a phase or a frequency of an audio signal is altered before the transmitting. A rolling code for the altering before the transmitting may be based on the ephemeral key.

A related problem in bot-to-bot communication is VA authentication. For example, a first VA may receive a telephone call and identify the caller as a second VA. The second VA may be a malicious VA masquerading as a bank and request private or confidential bank account information (e.g., associated with the user of the first VA).

According to a further technological solution provided by an aspect of the disclosure, in a registration phase, a first VA may store a first secret known to the second VA. The second VA may store a second secret known to the first VA. In this way, when bot-to-bot communication is detected, the first VA may request the second secret from the second VA. If the first VA receives the correct second secret from the second VA, then the first VA may transmit the first secret to the second VA. The second VA may then determine whether the first secret received from the first VA is correct. If so, then both VAs have validated each other and may commence secure communication, including the sharing of PII or other confidential information. In some implementations, in the registration phase, each VA may store the public encryption key of the other VA, and may then during the call it may use the public encryption key to encrypt the confidential information and transmit the encrypted information to the other VA.

In some embodiments, it may be sufficient to authenticate only one of the VAs using only one secret. For example, if the first VA calls a telephone number associated with customer service of a bank and the call is answered by a second VA on behalf of customer service, it may be sufficient if the first VA is authenticated to the second VA by the first VA transmitting a secret.

In some implementations, the first VA may initiate a call or other form of communication (e.g., text, email) to a user device associated with a user profile to request permission before transmitting confidential information to the second VA. For example, if the second VA is requesting transmission of confidential information, the first VA may reach out to the user device to request that the human approve the communication of confidential information.

A method, system, non-transitory computer-readable medium, and means for implementing the method are disclosed for bot-to-bot communication. Such a method may include: embedding, by a first virtual assistant (VA), a first signal within an outbound portion of a bi-directional audio channel for natural language communication; wherein the first signal indicates VA communication; receiving, by the first VA, a second signal embedded within an inbound portion of the bi-directional audio channel for natural language communication, wherein the second signal indicates VA communication and is generated by a second VA based at least in part on reception, by the second VA, of the first signal; and based at least in part on the receiving of the second signal: embedding within the outbound portion of the bi-directional audio channel, by the first VA, one or more non-natural-language messages to communicate with the second VA in a manner other than natural language audio.

In such a method, the one or more non-natural-language messages to communicate with the second VA may include: binary code embedded in the audio channel; text-based communication transmitted encrypted via the audio channel; out of-band packet transmission, such that the first VA and the second VA generate packets based at least in part on VA internal data; compressed data transmissions in a sub-band of an audio signal range of the audio channel. Such a method may also include: detecting an absence of a bot communication signal; and based at least in part on the detecting the absence of the bot communication signal, switching away in real time from the one or more non-natural-language messages to communicate with the second VA to voice communication via the audio channel directly intelligible to a human.

In addition, such a method may include detecting that a human is communicating via voice communication via the audio channel; and based at least in part on the detecting that the human is communicating via voice communication, switching away in real time from the one or more non-natural-language messages to communicate with the second VA to voice communication directly intelligible by the human.

Various types of signals are contemplated. For example, the first signal and the second signal may be human imperceptible. The first signal may be embedded by altering a phase of an audio signal segment to encode binary code-the binary code would thus represent the first signal. The first signal may be embedded as a predefined sequence of low-amplitude, wide-band signals representing binary code that is introduced into a spectrum of the audio channel transmitted, such that the binary code represents the first signal. In this way, at detection the predefined sequence of low-amplitude, wide-band signals is known in advance. The first signal may be embedded by transmitting low amplitude and delayed binary code, wherein the binary code represents the first signal, such that a delay in the transmitting is modulated to encode the binary code. Also envisioned is the variation in which the first signal is embedded by quantizing samples of audio code being transmitted such that quantization intervals correspond to binary code that represents the first signal-- the quantization intervals may thus be selected according to predefined rules, and at detection the predefined rules used to select the quantization intervals are known in advance. The first signal may be embedded by embedding binary code representing the first signal into predefined frequency domain components of the audio channel.

Also contemplated is a method that includes: determining by a first virtual assistant (VA) that a bi-directional audio stream session for natural language communication is with a second VA; based at least in part on the determining that the bi-directional audio channel session is with the second VA, transmitting to the second VA a request for an ephemeral encryption key, wherein the transmitting to the second VA the request for the ephemeral encryption key is transmitted by the first VA using an outbound portion of the bi-directional audio channel; receiving, by the first VA, in an inbound portion of the bi-directional audio channel, the ephemeral encryption key, wherein the ephemeral encryption key is selected by the second VA based at least in part on reception by the second VA of the request for the ephemeral encryption key; and transmitting to the second VA, by the first VA, data encrypted using the ephemeral encryption key.

Such a method may also include: transmitting to the second VA, by the first VA, an audible marker indicating that a following portion of communication comprises the data encrypted using the ephemeral encryption key.

Such a method may include: receiving from the second VA, by the first VA, a request for a second ephemeral encryption key; selecting by the first VA, the second ephemeral encryption key based at least in part on reception by the first VA of the request for the second ephemeral encryption key; transmitting to the second VA, by the first VA, the second ephemeral encryption key; and receiving, by the first VA, second data encrypted using the second ephemeral encryption key.

In such a method the data may be encrypted using analog scrambling such that a phase of an audio signal is altered before the transmitting, wherein a rolling code for the altering before the transmitting is based on the ephemeral encryption key. The data may be encoded using frequency inversion based on the ephemeral encryption key or split-band scrambling based on the ephemeral encryption key. The data may be encoded using the ephemeral encryption key is transmitted by the first VA using voice communication.

For example, the ephemeral encryption key may be a public encryption key, and a private key corresponding to the public encryption key is saved at the second VA. The ephemeral encryption key may be embedded using an audio watermarking technique. Such a method may include requesting, during the voice communication session, a second ephemeral encryption key; using the second ephemeral encryption key to encrypt a second piece of confidential information.

Such a method may include: determining that data to be transmitted to the second VA comprises information subject to data protection regulation comprising one or more of the Health Insurance Portability and Accountability Act, the California Consumer Privacy Act, or the General Data Protection Regulation, wherein the transmitting to the second VA a request for an ephemeral encryption key is based at least in part on the determining that the data to be transmitted to the second VA comprises the information subject to the data protection regulation. Also contemplated is a method that includes: determining by a first virtual assistant (VA) that a bi-directional audio channel session for natural language communication is with a second VA; based at least in part on the determining that the bi-directional audio channel session is with the second VA, transmitting to the second VA, by the first VA, a first secret registered with the second VA prior to the bi-directional audio channel session; receiving from the second VA, by the first VA, a second secret registered with the first VA prior to the bi-directional audio channel session; authenticating the second VA, by the first VA, based at least in part by determining that the second secret has been previously registered with the first VA; based at least in part on the authenticating the second VA, transmitting to the second VA, by the first VA, information via an outbound portion of the bi-directional audio channel of the bi-directional audio channel session.

In such a method, the data may be encrypted using analog scrambling such that prior to the transmitting, a phase or frequency of an audio signal is altered.

In such a method, the first VA may be associated with a first user profile and the second VA associated with a second user profile, and the method may include: transmitting an authentication request, by the first VA, to a user device associated with the first user profile, wherein the authentication request indicates the second user profile; and receiving a response from the user device approving the second user profile, wherein the authenticating the second VA may be performed only after receiving the response from the user device approving the second user profile.

When such a method is used, it may include: determining that the second VA is requesting confidential information; requesting, by the first VA, authorization from a user associated with a user profile before sharing the confidential information.

In such a method, during the bi-directional audio channel session the second secret may be received by the first VA via an inbound portion of a bi-directional audio channel of the bi-directional audio channel session.

Other aspects and features of the present disclosure will become apparent to those ordinarily skilled in the art upon review of the following description of specific embodiments in conjunction with the accompanying figures.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 illustrates signaling in voice communication between virtual assistants for switching to bot-to-bot communication, according to an example of an aspect of some embodiments of the present disclosure;

FIG. 2 illustrates mutual identification between virtual assistants through signals embedded in an audio channel, according to an example of an aspect of some embodiments of the present disclosure;

FIGS. 3A and 3B illustrate a sequence diagram of system communication and processing flows including normal human interaction mode, bot detection mode, and bot-to-bot communication mode, according to an example of an aspect of some embodiments of the present disclosure;

FIG. 4 contains a table illustrating bandwidth of some of the most used telephony codecs illustrates an example of feature extraction and compilation, according to an example of an aspect of some embodiments of the present disclosure.

FIGS. 5 and 6 contain examples of Session Initiation Protocol (SIP) code for OPTIONS methods for discovering capabilities of the virtual assistant with which it is communicating, according to an example of an aspect of some embodiments of the present disclosure;

FIG. 7 illustrates a computer system for implementing methods described herein, according to an example of an aspect of some embodiments of the present disclosure;

FIG. 8 illustrates computing devices communication via one or more networks, according to an example of an aspect of some embodiments of the present disclosure;

FIG. 9 illustrates a flowchart showing a bot recognition process, according to an example of an aspect of some embodiments of the present disclosure;

FIG. 10 illustrates bot-to-bot signaling for transmitting encrypted confidential communication, according to an example of an aspect of some embodiments of the present disclosure;

FIGS. 11A-11D illustrate private key-public key approaches for secure communication and sender authentication, according to an example of an aspect of some embodiments of the present disclosure;

FIG. 12 illustrates a technique for protecting confidential communication in bot-to-bot communication, according to an example of an aspect of some embodiments of the present disclosure;

FIG. 13 illustrates a challenge secret and response secret technique for authenticating a virtual assistant in bot-to-bot communication, according to an example of an aspect of some embodiments of the present disclosure;

FIG. 14 illustrates a technique for establishing mutual authentication in a bot-to-bot voice exchange, according to an example of an aspect of some embodiments of the present disclosure;

FIG. 15 illustrates a technique for human in the loop information sharing request in a bot-to-bot voice exchange, according to an example of an aspect of some embodiments of the present disclosure;

FIG. 16 contains a flowchart showing secure sharing of confidential information in a bot-to-bot communication process, according to an example of an aspect of some embodiments of the present disclosure;

FIG. 17 contains a flowchart showing virtual assistant authentication by another virtual assistant in in a bot-to-bot communication process, according to an example of an aspect of some embodiments of the present disclosure;

FIG. 18 contains a flowchart for using signaling to determine that communication is between VAs in a bi-directional audio channel session for natural language audio communication, according to an example of an aspect of some embodiments of the present disclosure;

FIG. 19 contains a flowchart showing secure sharing of confidential information between VAs, according to an example of an aspect of some embodiments of the present disclosure; and

FIG. 20 contains a flowchart showing virtual assistant authentication by another virtual assistant, according to an example of an aspect of some embodiments of the present disclosure.

The drawings are intended to depict only typical aspects of the subject matter disclosed herein, and therefore should not be considered as limiting the scope of the disclosure. Those skilled in the art will understand that the structures, systems, devices, and methods specifically described herein and illustrated in the accompanying drawings are non-limiting exemplary embodiments and that the scope of the present invention is defined solely by the claims.

### DETAILED DESCRIPTION

Virtual assistants (VAs) are increasingly common to automate tasks like making doctor's appointments, reserving a table at a restaurant, and booking travel. At the other end, businesses are using VAs to receive calls from customers and perform related tasks. While convenient, a disconnect may occur when two VAs are attempting communication without an ability to identify that both are VAs. For example, a VA may identify that it is communicating with another bot using embedded signals to recognize the other VA and then use a communication mode more efficient than human voice communication. Related functions are provided. For example, a VA is configured to process voice commands and to communicate using a synthesized human voice, e.g., through Automatic Speech Recognition (ASR), a Small Language Model (SLM) or a Large Language Model (LLM), and Text-to-Speech (TTS) modules. Moreover, for example, a VA may be configured to detect human presence and switch to human voice communication mode when necessary. Further, for example, confidential information may be securely transmitted between bots using ephemeral encryption keys. In addition, for example, bots may be authenticated to prevent unauthorized access by using challenge-response authentication with pre-registered secrets or cryptographic signatures. Furthermore, for example, to comply with data protection regulations, encryption and secure communication protocols are used to protect personal information.

In some embodiments, a first VA communicating via an audio channel for natural language communication, such as voice over internet protocol, may be aided in determining that it is communicating with another VA, not a human. The phrase “natural language communication” may refer to the type of language spoken between humans in everyday contexts. It may include words or phrases of any human language or dialect, as well as non-verbal sounds, such as those associated with laughing, scoffing, crying, etc. The meaning of natural language communication can be nuanced and context-dependent, making natural language potentially difficult to understand by machines. By contrast, non-natural language communications (such as formal programming languages) are often designed for efficiency and easy of understanding by machines. In some embodiments this may be achieved by the first VA embedding, in the audio channel, a first signal flagging itself as a VA, not a human. If the VA receives a second signal embedded within the audio channel that also flags the second VA as a VA, then communication may continue using a bot-to-bot communication mode with non-natural-language messages, for more efficient communication. Or, bot-to-bot communication may use natural human language using a synthesized human voice several times faster than the rate at which humans normally communicate. For example, such bot-to-bot communication may be 3-12 or 2-20 times the speed of ordinary human speech, which humans may or may not be able to process. In some embodiments, a first VA may encrypt confidential information by first requesting an ephemeral encryption key from the second VA. The first VA may then use that received ephemeral encryption key to encrypt the confidential communication. In some embodiments, the first VA may authenticate a second VA by transmitting a challenge secret to the second VA. If the first VA receives a response secret from the second VA, then the first VA may authenticate the second VA.

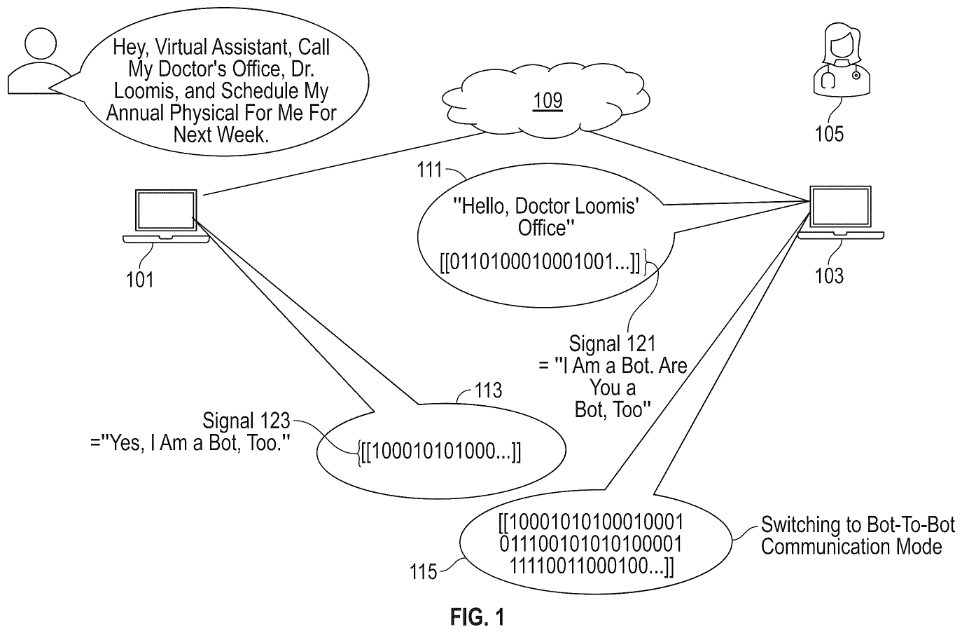

In some embodiments, as illustrated, for example, in FIG. 1, a virtual assistant 101 receives a voice command from a user. For example, the voice command may include a request to perform a specific task. In this case the task is to contact the user's doctor's office to schedule a medical appointment for the user. The virtual assistant 101 may be provided on a computing device, such as a mobile device, for example, a smartphone or tablet; a laptop computer; a personal computer; a desktop computer; a smart television; a smart watch or wearable device; a camera; smart glasses; a stereoscopic display; a wearable camera; XR glasses; XR goggles; XR head-mounted display (HMD); near-eye display device; a set-top box a streaming media device; or any other suitable device; or any combination thereof. The VA may reside on a remote site, such as on a server. The virtual assistant 101 may receive the voice command from the user directly in real time, or may receive the voice command via network communication. For example, the user may use a terminal or smartphone for voice communication with the virtual assistant 101 or may transmit a request using communication other than voice communication, such as text, email, or an application designed for human-virtual assistant communication. The VA 101 may initiate a call automatically, for example, in response to a task scheduled in a calendar, in response to an email received for which the system is programmed to respond, or may be triggered to call in response to some other automated tool.

Having received the command, the virtual assistant 101 may incorporate or have access to an Automatic Speech Recognition (ASR) module that receives the speech data, which can provide a prompt to a large language module (LLM) or a small language module (SLM) that provides AI functionality for generating a reply, and a text-to-speech (TTS) module that generates voice communication for communicating with the node that the virtual assistant 101 is instructed to call. The virtual assistant 101 may use one or more types of voice communication, such as voice over IP (VOIP) or plain old telephone (POTS), to call the medical office for interacting with a user or a bot at the destination node via network 109.

The ASR may take an audio stream or data in an audio buffer as input and return one or more text transcripts, along with additional optional metadata. Speech recognition may entail a GPU-accelerated compute pipeline, with optimized performance and accuracy. Offline/batch and streaming recognition modes may each be provided. The text may then be fed to an SLM or to a large language model (LLM). An SLM may be used for user interactions of a specific setting and may be used even with less data than an LLM, which may be sufficient to deliver accurate responses with speed adequate for conversing with a human user in real time. Using an SLM, (e.g., noncritical) outputs may be pruned or removed to reduce the parameter size of the model.

The output produced by the SLM (or an LLM) may be input to the TTS pipeline. The TTS pipeline may entail first generating a spectrogram using a first model, and then generating speech using the second model. A spectrogram may be a representation of the spectrum of frequencies of a signal as it varies with time. Such a TTS pipeline may be configured to synthesize natural sounding speech from (e.g., raw) transcripts, e.g., without any additional information such as patterns or rhythms of speech. Audio generator may be connected to, or comprised as part of, a Wi-Fi router, a set-top-bot (STB), desktop/laptop or another computing device. Virtual assistant 101 may also incorporate or have access to an audio to face (Audio2Face) module to simulate a face talking and/or uttering the words being said. In this way, the user's digital voice assistant may be able to identify information for making the call. This may entail processes in which the virtual assistant may identify in a contact list stored on one or more of devices or online accounts (e.g., a smartphone, laptop or other computing device or user's online profile associated with a user whose voice the VA recognizes as issuing the request for the task or a with user registered with the VA), or based on a call log, the telephone number associated with the medical office of Dr. Loomis. Further, the VA may determine scheduling of a task or appointment. For example, the VA may determine an availability of the user on the day requested for the appointment based on a calendar in a smartphone, laptop or other computing device or user's online profile associated with the user, and may access the user's personal information, such as user's name and date of birth which are usually required to make doctor's appointments.

The call from virtual assistant 101 may be answered at the destination node by a human (e.g., a receptionist at the medical office) or by a second virtual assistant 103, as also shown in FIG. 1. Neither virtual assistant 101 nor virtual assistant 103 may realize, at least initially, that it is communicating with another voice assistant. The call initiated by the first VA 101 may be a bi-directional audio channel that allows the parties on both ends of the communication line to speak and be hear: the outbound portion of the bi-directional audio channel for the first VA 101 is the inbound portion of the bi-directional audio channel for the second VA 103. As shown at 111, the second VA 101 may start communicating with the first virtual assistant 101 using ordinary voice communication. The virtual assistant 103 may answer using ordinary voice communication and also insert a signal 121 that identified itself as a bot. The signal 121 may also indicate a request asking whether the virtual assistant 101 happens to be a bot.

At 113, the first virtual assistant 101 may reply with a response signal 123, identifying itself as a bot. Thereafter, the virtual assistant 101 and the virtual assistant 103 may switch to bot-to-bot communication mode.

As shown at 115, the virtual assistant 103 may transmit a message 115 using the bot-to-bot communication mode.

In some embodiments, at the time of call setup, the VAs may exchange data regarding bot-capable behavior and an application programming interface (API) set. For example, the VA that initiates the call, prior to the audio call, or at the time of the audio call setup, may provide information related to the API-set that it supports for bot-to-bot communication or that it requires for bot-to-bot communication. It may also request bot-to-bot communication, for example, using one or more of the signaling processes described herein.

The second VA receiving the call may determine whether the API-set indicated by the calling VA is supported and respond accordingly (e.g., by signaling its acceptance of the request to switch to bot-to-bot communication. Based on the second VA's reply, the calling VA may terminate its attempt to set up the audio call and directly communicating via the API, or may decline the bot-to-bot communication and proceed with natural language voice communication. Similarly, prior to natural language voice communication, the second VA receiving the call may signal a request to for bot-to-bot communication and, if accepted by the calling VA, the VAs may proceed to bot-to-bot communication without any natural language voice communication.

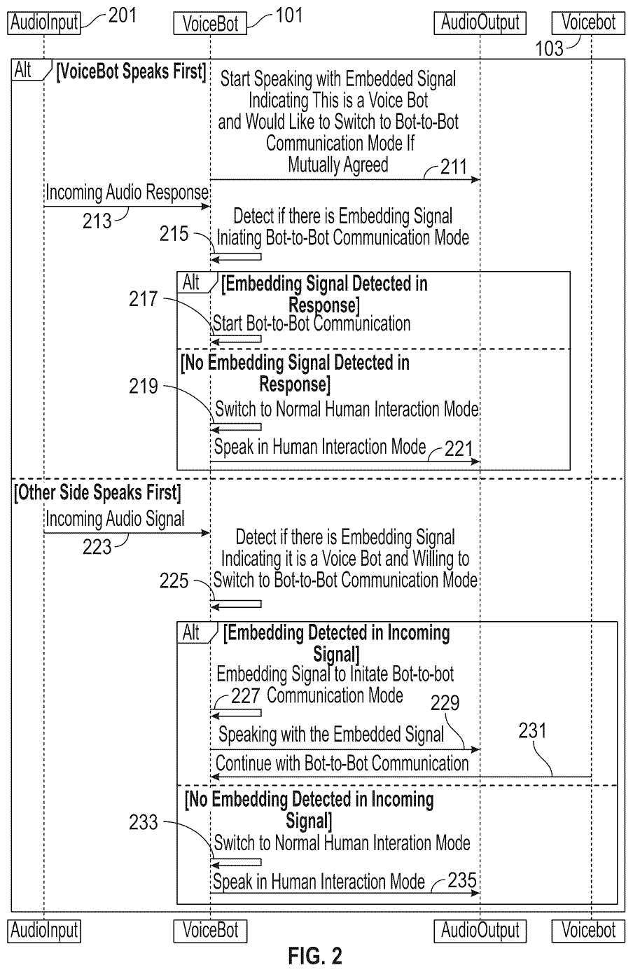

FIG. 2 illustrates communication between virtual assistant 101 and the target node when the call is answered by second virtual assistant 103.

At 211, virtual assistant 101 may begin speaking with the target node and, not knowing whether it is speaking with another virtual assistant or with a human, it may embed a signal that identifies itself as a bot and indicates that it would like to switch over to bot-to-bot communication if mutually agreed. The signal may be embedded after the virtual assistant 101 has begun speaking with the virtual assistant 103. For example, the virtual assistant 103 may answer with a greeting such as “hello, this is Get Well Now medical office,” and the virtual assistant 101 may respond with “Hello I'm calling on behalf of Mr. Smith, who would like to make an appointment.”

In some implementations, the signal may be embedded at the very beginning of the conversation before any human intelligible words are uttered. For example, the signal may be an out-of-band signal that may be transmitted before or after the phone call is answered by the second virtual assistant 1-3. The signal may comprise one or more of many types of signals as described below. In an embodiment, the first signal may be embedded by the second virtual assistant 103 at the node that receives the call, as shown in FIG. 1, such that the first virtual assistant may then reply with the response signal, or the first signal may be embedded by first virtual assistant 101.

At 213, virtual assistant 101 may receive a response signal indicating that the target node it is answering via a second virtual assistant 103. The response signal may comprise one or more of many types of signals as described below. The second virtual assistant 103 may repeat the same signal with that received from virtual assistant 101 at 211, or may generate a second signal different from the first signal.

At 215, virtual assistant 101 may detect the receipt of the answer signal and may thus be informed that it is in communication with and another virtual assistant at the target node. Based at least in part on this information, at 217 the virtual assistant 101 may initiate bot-to-bot communication with the second virtual assistant 103. The bot-to-bot communication may be unintelligible or even imperceptible to humans. The bot-to-bot communication may comprise one or more of many types of communication as described below.

Such bot-to-bot communication may continue until the virtual assistant 101 has completed its task of scheduling an appointment with the medical office as instructed by the user. One or more additional tasks may also be accomplished for example the second virtual assistant may inform the first virtual assistant that the user has an outstanding balance. The bot-to-bot communication may finish and the call may end. The bots may insert or modify a flag/syntax in the voice/audio bitstream. Such an approach may avoid challenges caused by baseband signal processing, compression, etc. Such signaling can be at various levels, e.g., elementary stream, transport stream, etc. Also, at the start of a session, a high-level indication can be used to signal that the session will have a bot involved-taking over the conversation. In some embodiments, a signal may be sent that a bot will not be involved in the call and so no further signaling and monitoring for a signal is provided. In some embodiments, such a signal may be automatically transmitted unless a bot transmits a signal that it is present in the call.

In an embodiment, a human may be detected by one or more or all of the virtual assistants as attempting to communicate in the call. For example, a receptionist may pick up the receiver and start talking or the user may interrupt, for example, to add something to supply additional information to the conversation. In an embodiment one or more of the virtual assistants may request help from a human. For example, the virtual assistant 101 may contact the human to request an alternate appointment slot from the human if the first appointment slot initially suggested body human is unavailable at the medical office. The first virtual assistant 101 may contact the human standing nearby using voice communication audible to humans or the first virtual assistant 101 may use electronic means, such as text to a device associated with a user profile, or a separate voice call to contact the human to request the information or other human intervention in the call. In response, to such human intervention, at 219 one or both of the virtual assistants may switch to human voice communication intelligible to humans. At 221, the conversation is continued in such human interaction mode.

In some embodiments, the first signal and the response signal from the second virtual assistant 102 may be periodically or episodically repeated. For example, unless the first virtual assistant 101 receives the response signal from the second virtual assistant (in response to the signal from the first virtual assistant 101 that the first virtual assistant 101 periodically or from time to time transmits), the bot-to-bot communication may be automatically halted.

In some embodiments, the bot-to-bot portion(s) of the conversation may be recorded for later review by a human. For a session to be recorded, the bot-to-bot part may be converted to audible voice, and its location in a longer human conversation logged, or the bot-to-bot communication may be automatically transcribed to text form. The conversion to human voice recording or to a text transcript thereof or a summary of the content may be done in real time or may be done automatically after the call or in response to request. The bot-to-bot communication and/or the converted voice or text transcript or summary may be stored locally at the same node as one or both of the VAs or may be stored online. An ML model may summarize the communication content, regardless of whether it is or is not natural language human voice. For example, if it is in a binary form, or a set of data, this may be transcribed in human words. The bot-to-bot communication or text transcript or summary may be recorded, instantly transmitted and played at another node (e.g., the system may generate in real time a human intelligible version of the bot-to-bot for a human who is supervising the customer service bot). This may be enabled along with transcription that indicates segments of conversation by human and/or bot.

Also illustrated in FIG. 2 is a scenario in which the first virtual assistant 101 speaks first, in this case answering an incoming audio call from another virtual assistant. At 223, the first virtual assistant 101 receives an incoming audio call and hears the other VA 103 speaking first. At 225, the first virtual assistant detects whether there is an embedded signal in the call indicating that the caller is a bot and that the second virtual assistant 103 is willing to switch to bot-to-bot communication mode. For example, the first virtual assistant 101 may be instructed in advance that it is always to enter bot-to-bot communication mode if at all possible. Or the first virtual assistant 101 may be instructed that it never is to enter bot-to-bot communication. In an embodiment, the first virtual assistant 101 may be instructed that only certain types of target nodes may be engaged with in bot-to-bot communication mode. For example, the first virtual assistant 101 they have an allowed list that enumerates the target nodes with which it is allowed to enter bot-to-bot communication mode. Or the first virtual assistant 101 may have a block list that enumerates target nodes with which it is not allowed to enter bots bot communication. For example, the signal and/or the response signal may include an identifier of the virtual assistant that transmits it so that the receiving virtual assistant can be informed of the identity of the virtual assistant that transmits the signal, of the node associated with the virtual assistant that transmits the signal, or of the type of entity (e.g., residence, commercial, overseas, medical office, bank, mechanic, spam, etc.). In an implementation, the virtual assistant that receives the call may authenticate the calling virtual assistant, for example, using one or more of the authentication methods described in detail below.

In a further implementation, the first virtual assistant may be instructed that it is allowed to initiate bot-to-bot communication with other bots that it calls but it is not allowed to enter bot-to bot communication with bots when the calling bot attempts to initiate bot-to-bot communication. In an implementation, the first virtual assistant may be instructed to request permission from the user each time bot-to-bot communication mode has been requested by a calling bot or to always first request permission from the user before attempting to establish bot-to-bot communication mode.

If the signal is present and if the first virtual assistant 101 is approved by the user to use bot-to-bot communication mode, then at 227 the first virtual assistant may embed a response signal indicating that it would like to switch to bot-to-bot communication mode. At 229, the first virtual assistant 101 transmits the response signal to the second virtual assistant 102.

At 231, bot-to-bot communication mode may continue until the conversation is finished, for example if the tasks assigned to the respective virtual assistant are completed.

As shown at 233, if one or both of the virtual assistants detect the presence of a human on the line, for example if a human voice is detected or if one or both of the virtual assistants detect that another receiver has joined the conversation then they may determine that a human interaction mode is to be started or resumed. Bot-to-bot communication may cease and bot to human communication may start (or resume) at 235. In some scenarios the call may start off as a human communicating with a bot and then a bot may take over for the human. In an implementation, a human may be communicating (e.g., simultaneously) with a human and on the same voice call the bot may also be present to process and/or control some tasks. For example the human may instruct the bot to schedule the medical appointment for the human with the medical office and while the bot that is communicating with the customer service bot of the medical office to schedule the appointment at a mutually convenient time, the user may communicate with the virtual assistant or with human personnel at the medical office to review symptoms or to discuss other aspects of the user's health status. Thus, the same voice over IP communication may be simultaneously used by humans communicating with each other and bots communicating with each other, or by a human communicating via the call with the second virtual assistant. In this example, the bot-to-bot communication may be imperceptible to the human, or may be audible to the human but not disruptive to the human communication occurring simultaneously over the same voice communication channel. In some embodiments, one or both of the VAs detecting the human communication during their bot-to-bot communication may automatically start a second call, or may schedule a second call for a future time, to continue their bot-to-bot communication.

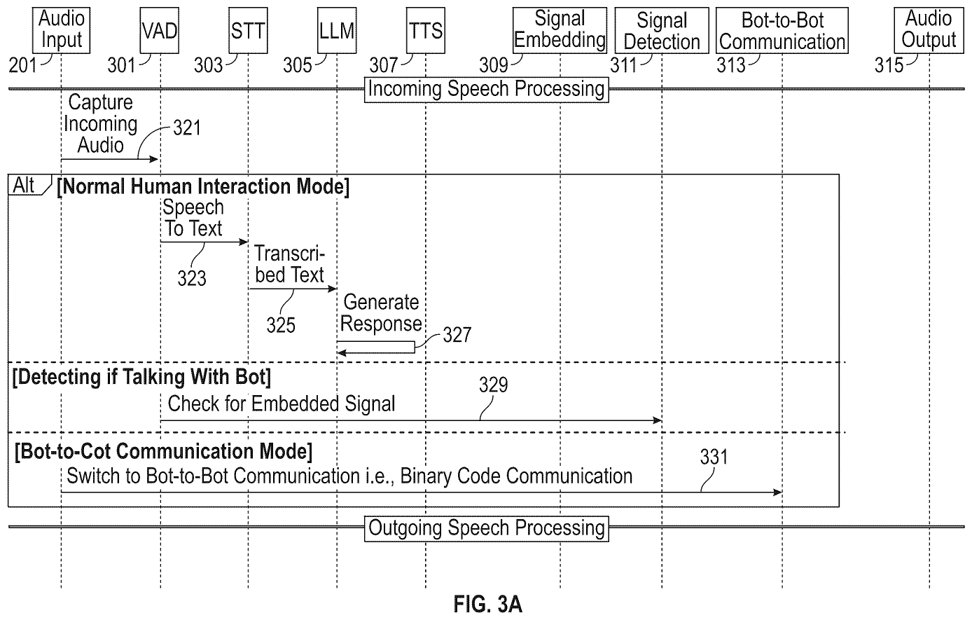

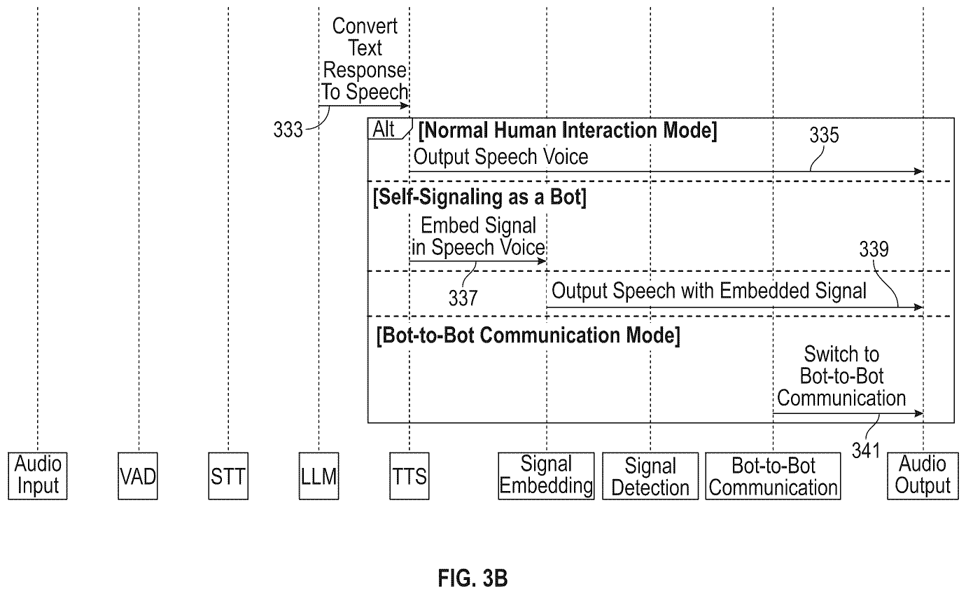

FIGS. 3A and 3B contain a sequence diagram of a bot system architecture, with operational flows including normal human interaction mode, bot detection mode, and bot-to-bot communication mode. A workflow of a bot system includes systems such as, for example, voice activity detection (VAD) 301, speech-to-text (STT) 303, text-to-speech (TTS) 307, large language model (LLM) 305, signal embedding, signal detection, and bot-to-bot communication. The system operates in three main modes: Normal Human Interaction Mode, Bot Detection Mode, and Bot-to-Bot Communication Mode.

At 321, incoming speech may be processed by audio input 201, which may capture incoming audio. This may be initially processed by VAD 301 to detect whether the input contains speech. The system may first determine whether it should proceed with normal human interaction, bot detection, or bot-to-bot communication. The determination logic is described and illustrated in FIG. 2.

In normal Human Interaction Mode, at 323 captured audio may be passed to the STT module 303, which converts speech to text. At 325, the transcribed text is then input to the LLM 305, and processed at 327 by the LLM 305 to generate a suitable response.

Bot detection mode may start at the very beginning of the conversation. The virtual assistant that receives the first voice input may launch, or may already have initiated, the bot detection mode. In this mode, at 329 the signal detection module 311 may check the incoming audio for an embedded signal. If no such signal is detected, it may default to the normal human interaction mode. If such a signal is detected, then it may at 331 prepare to initiate a bot-to-bot communication mode by sending one or more voice signal with embedded response signals indicating this is also a bot and is willing to establish a bot-to-bot communication channel. If both bots detect that they are interacting, and agree on bot-to-bot communication, the system may switch to this bot-to-bot communication mode, where communication is performed through more efficient means, such as binary code embedded in the audio.

In a scenario in which the first virtual assistant initiates a voice call, the virtual assistant 101 may generate text using the LLM 305, which at 333 may pass the text to the TTS module 307, which may convert the text into speech for output at 335. In normal Human Interaction Mode, the generated speech may be passed at 335 directly to Audio Output 315 for playback as normal human-like speech for the other party.

If the bot is the first speaker of the conversation, and if it is willing to tell the other party that it is actually a bot, then at 337 Signal Embedding module 309 may insert a signal to the audio output 315, marking the bot's presence, which may then be transmitted at 339 as part of the voice signal. In a configuration, the signal may identify the virtual assistant 101 so that the second virtual assistant may use the signal to authenticate it.

In some implementations, a user interface may be provided to control whether or not the virtual assistant 101 is to attempt to initiate bot-to-bot communication mode, whether or not the virtual assistant 101 is to identify itself as a bot when requested by another bot, whether or not the virtual assistant 101 is to agree to enter bot-to-bot communication mode when initiated by another bot, with which other bots and/or under what circumstances the virtual assistant 101 is to attempt to initiate bot-to-bot communication mode, is to identify itself as a bot when requested by another bot, and/or is to enter bot-to-bot communication mode.

At 341, bot-to-bot communication mode is entered to continue communication. If the system is in bot-to-bot communication mode, the bot-to-bot communication module 313 may take over, using one or more of various types of communication as described below, for example, binary code communication, to exchange data between the bots.

The signals to identify the transmitter of the voice data as a bot may be inserted using one or more techniques, sometimes referred to as audio watermarking or information hiding, or may be a high-pitched trill or the like A goal may include to embed an identifier (sometimes referred to as a watermark) into the audio stream without affecting the quality of the audio. In an embodiment, the signal may remain unintelligible, or may even remain imperceptible, to human listeners using a naked ear while being detectable by automated systems. Each embedding technique has a corresponding detection method that may enable identification of the watermark during audio processing.

In an embodiment, phase coding may be used both to embed and to detect a watermark. For embedding, the phase of one or more segments of the audio signal may be altered to encode the identifier, such as a bot ID. The human ear is largely insensitive to phase changes, making this method effective and mostly or completely imperceptible. Detection may be performed by the receiving bot by analyzing the phase of each audio segment in the incoming stream and comparing it to the expected phase. By identifying one or more phase changes, the system detects the presence of the watermark. This method may have the advantage that it has minimal impact on the perceptual quality of the audio, and may be less affected by compression algorithms than are amplitude-based methods. Since many telephone compression methods are based on amplitude compression and frequency filtering (e.g., G.711, G.729, AMR), phase coding may offer robustness.

In an embodiment, spread spectrum techniques may be employed to embed and to detect a watermark by distributing data across a wide frequency spectrum of the audio signal. For embedding, a low-amplitude, wide-band signal may be introduced into the audio spectrum using pseudo-random sequences to control the process. The spread spectrum technique may be configured to render the watermark difficult to remove or to detect without a specific key. During detection, the system correlates the received audio signal with the known spread spectrum sequence to extract the embedded watermark. This method may be highly robust against noise and audio compression, making it ideal for environments where the audio may be degraded, such as the compression schemes used in telephony. Also, this method may be used to authenticate the transmitting bot because typically the spread spectrum sequence being used would have to be agreed to in advance by the transmitter and the receiver nodes.

In an embodiment, low-bit encoding, also known as least significant bit (LSB) encoding, may be used for embedding and detecting information in the LSBs of audio sample values. To embed the signal, the LSBs of each audio sample may be replaced with the watermark bits, such as a binary representation of bot identifiers. This embedding method may operate at a very fine level, ensuring that the watermark is imperceptible to listeners. For detection, the system may analyze the LSBs of the incoming audio stream to retrieve the embedded data. Low-bit encoding may offer a simple and efficient solution, particularly suitable for short messages in clean audio conditions.

In an embodiment, echo hiding may be used for embedding and detecting a watermark by introducing echoes (e.g., small echoes nearly or completely imperceptible to humans) into the audio signal. The embedding process may include adding delayed versions of the original signal at low amplitudes, with the delay time or amplitude modulated to encode binary data (0s and 1s). To detect the watermark, the system may analyze the timing and amplitude of delayed signals in the incoming audio, identifying the presence and characteristics of the echoes to reconstruct the embedded data. Echo hiding may be difficult to detect or remove, making it suitable particularly for environments where security and audio quality are paramount. An echo inserted as a relatively low-frequency alteration may tend to survive the frequency and time domain alterations introduced by telephone compression techniques like AMR or G.729 codecs.

In an embodiment, quantization index modulation (QIM) is applied to embed and detect watermark information by modifying the quantized values of the audio signal [11]. For embedding, the audio samples are quantized, and the watermark may be embedded by altering the quantized values according to predefined rules, such as adjusting the quantization intervals to represent binary data (0 or 1). During detection, the system may examine the quantized values of the incoming audio signal and interprets any changes in the quantization intervals to retrieve the embedded watermark. QIM may be resistant to noise and lossy compression, making it robust for various audio processing environments. QIM can be made robust by ensuring that the modifications to the quantization levels are larger than the distortions caused by telephone compression, so the watermark remains intact even after compression.

In an embodiment, frequency domain watermarking may be used to embed and to detect a watermark by transforming the audio signal into the frequency domain. For example, techniques such as the Fast Fourier Transform (FFT) or the Discrete Cosine Transform (DCT) may be used. For embedding the signal, the watermark may be introduced into specific frequency components of the transformed signal before converting it back into the time domain. Detection may entail transforming the received audio back into the frequency domain and analyzing the frequency components for the embedded watermark. This method may be robust against audio distortions and signal processing attacks, such as compression or filtering. Also, the method is well-suited for applications configured to maintain the integrity and quality of the audio.

For example, the watermark may be embedded in one or more frequency bands that are preserved by telephone audio compression (typically 300 Hz to below 4 kHz). Compression algorithms such as G.729 or AMR may reduce the precision of frequency representation, but if the watermark is embedded in a way that adjusts these magnitudes beyond the threshold of compression distortions, it can survive. Alternatively, the watermark may be embedded within multiple frequency bands with redundancy which may allow a greater resistance to compression variations (e.g., different codecs) than embedding the watermark in the untouched or little altered frequency bands that covers all compression algorithms.

In some embodiments, the bot-to-bot communication may entail natural human language communication at a faster rate than the rate at which humans ordinarily talk (e.g., “normal speed”). For example, the bot-to-bot communication may be at 4-6 times normal speed, or 2-10 times normal speed.

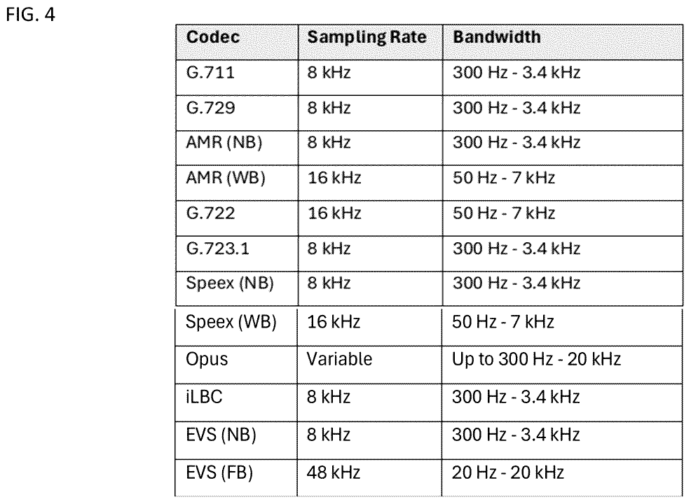

FIG. 4 contains a table that illustrates various bandwidths of some of the most used telephony codecs. The codecs may impose restriction on the kind of frequency manipulation that may be applied to embed the watermark. More than one such frequencies may be used for a signal, and the virtual assistant that received the signal may use a different frequency, or a different set of frequencies for the response signal than was used for the initial signal.

When both bots have mutually detected each other and are willing to switch to a bot-to-bot communication mode. One or more methods may be employed for the bot-to-bot communication, prioritizing efficiency, speed, and minimal resource usage compared to regular human-interaction modes.

In an embodiment, binary code communication may be embedded in the audio stream. Instead of traditional voice communication, the bots exchange data via binary codes. The binary data may be embedded using techniques such as spread spectrum or low-bit encoding. Such data may include session information, commands, or structured data packets. Using this approach, simple, fast exchanges of binary data may be obtained, and this may reduce the overhead associated with generating and processing natural speech, eliminating speech synthesis and recognition, which may reduce computational overhead for both bots.

In an embodiment, text-based communication may be transmitted via encrypted audio. Rather than exchanging full speech audio, the bots may transmit textual information over the audio channel using encryption techniques. Each bot may convert an intended message into a textual representation, which may be then encrypted and embedded in the audio stream using methods such as phase coding or frequency domain watermarking. The receiving bot may then decode and decrypt the message. Various encryption techniques may be used and are discussed below. This method may provide for data security during transmission, reduce the time required for message construction and interpretation, and allow for more complex data structures or commands to be transmitted between bots. Text-based communication may also use binary code communication with the text represented in binary code.

In an embodiment, bots may transmit data packets directly over the audio stream, bypassing human language constructs altogether. Using this approach, bots may convert their internal data (e.g., task status, command requests) into a series of packets, which are then embedded in the audio stream using techniques such as echo hiding or quantization index modulation (QIM). The receiving bot may decode the packets, reconstructs the data, and respond accordingly. This approach may be similar to network communication, providing a well-understood and scalable method that ensures reliable data transmission, including error correction, e.g., to reduce a risk of packet loss.

In an embodiment, the bots may mix both voice and data using a hybrid communication approach. The bots may alternate between speaking in natural language for specific sections of the conversation and embedding structured data in binary or encrypted text for more complex exchanges. For example, bots may provide system status updates using human speech while exchanging commands and data in the background using binary encoding. Also, for example, the method provides flexibility, allowing bots to process mixed-mode communication (e.g., when provided) while reducing latency and optimizing communication when possible.

In an embodiment, compressed data may be exchanged using audio sub-bands. Bots may transmit compressed data by embedding it into specific sub-bands of the audio signal, rather than using the entire frequency spectrum. Compressed representations of internal data, such as task progress or system state, may be embedded in these sub-bands using frequency domain watermarking. The receiving bot may decode the compressed data from the relevant frequency ranges. This approach may minimize interference with other communications and may reduce bandwidth usage by compressing the data prior to transmission, making it suitable for efficient transmission of large amounts of data.

In an embodiment, silent communication may be performed using inaudible frequencies. Bots may transmit data using inaudible frequencies that cannot be detected by human listeners, allowing for completely silent communication without disturbing ongoing human conversations. Bots may encode and transmit data using ultrasonic frequencies (above 20 kHz) or subsonic frequencies (below 20 Hz), which are then detected by the receiving bot and decoded into structured data. This method may be used in environments where silent operation may be required or desirable, utilizing frequency ranges that do not interfere with simultaneous human speech or other audible sounds in the voice channel and/or in the physical vicinity of the bot generating the communication.

In an embodiment, an artificial intelligence (AI)-assisted bot-to-bot protocol with context awareness may be employed. For example, bots may use a trained machine learning model to dynamically negotiate a custom communication protocol based on the context of the interaction. This includes adapting the communication structure depending on the task complexity, message length, message content sensitivity/confidentiality, previous bot-to-bot communication mode(s) used by one or both of these bots, commonly used bot-to-bot communication mode(s) used by bots in this industry, in this geographic area, in this type of communication, or in this type of calling/receiving node (e.g., call to a medical office which may handle patient data regulated by law versus call to a restaurant making reservations for the user), urgency, and other such considerations. Once the bots detect each other, the AI-driven negotiation phase may begin, where bots agree on parameters such as binary transmission protocols, packet size, and error handling rules.

The AI may recommend a communication pattern based on interaction history, the confidentiality of data to be transmitted and other task requirements and other such factors. The AI may recommend or impose the specific type of bot-to-bot communication mode, and may do so before the bot-to-bot communication starts or may recommend a different bot-to-bot communication mode after a bot-to-bot communication has started. The AI may provide an encryption code or key that is to be used to encode the signal and the response signal that informs the bots that bot-to-bot communication may be enabled. The AI may provide an encryption code or key that is to be used for the bot-to-bot communication (e.g., for spread spectrum bot-to-bot communication). The AI may reside on one or both of the bots in the voice call or may reside elsewhere, for example, on a third-party server. For example, one or both of the bots may transmit a request to a server where the AI resides to request one or more of the above-described functions. This method may provide for efficient communication tailored to the specific context and may dynamically adjust to the communication associated with the task at hand.

In the course of the call, the mode of communication may be switched from human mode to bot-to-bot communication mode and/or from bot-to-bot communication mode to human mode, and this switch may be done more than once. If one of the parties is human, then human mode may be selected. Nonetheless, the human may inform the other party that the call may be handed off to a bot. If the other party is a bot, then the human informing the other party that the call may be handed off may be detected by the LLM, thus enabling the establishment of bot-to-bot communication. In an implementation, if the human does not indicate during the call that bot-to-bot communication mode is to be allowed, then bot-to-bot communication mode may be disabled for the call. According to this implementation, since the human has requested no bot-to-bot communication for the bots, when the human hands off communication to the first virtual assistant 101, the first virtual assistant 101 does not signal to the second virtual assistant 103 that it is a bot, or the second virtual assistant 103 does not respond with a signal indicating that it is a bot.

In some implementations, if the human fails to inform the other party that the call may be handed off to a bot, then bot-to-bot communication mode may be disabled for the call. If the two bots are in a bot-to-bot communication mode, then if a bot detects that a human has entered the conversation, then the bot-to-bot communication may be stopped and normal human voice signal mode may be initiated or resumed.

In some embodiments, “out-of-band signaling” (e.g., a control plane function) may be used by an end system (calling party and/or called party) to advertise that it is capable of conforming to a known bot-capable network API, or to respond to such a message. Out-of-band signaling may operate in the control plane of the communication system, separate from the main audio communication (the media plane), may operate in the data plane, or may operate in both the control plane and the data plane. Such signaling may be configured so that one or both of the bot systems may exchange identification and capability information before or during the call setup. In some implementations, one or both bots have access to the communication layer, such as the telephony system or the signaling protocol, which manages call setup and call teardown.

According to such approaches, the bot system does not embed the signal in voice communication but may use out-of-band signaling to facilitate bot identification. One or both bots may use out-of-band signaling to facilitate the bot-to-bot communication, or portions thereof, or may use the out-of-band signaling for other aspects of the bot-to-bot interaction. This approach may allow a more structured and formal exchange of bot-related information, enabling better coordination between bot systems and their communication environments.

For example, SIP (Session Initiation Protocol) is a Hypertext Transfer Protocol (HTTP)-like protocol used to establish and teardown VoIP audio calls. A SIP client (UAC-User agent client) may use an INVITE message that contains Header fields to initiate a call to another end point (UAS-User Agent Server) that establishes a route via SIP proxies. The Header field formats may be extended to include a field that indicates that the UAC or UAS are robotic entities and conform to a certain (named) API set.

Further, the SIP method OPTIONS allows a User agent (UA) to query another UA or a proxy server as to its capabilities. This allows a client to discover information about the supported methods, content types, extensions, codecs, etc. without notifying (e.g., “ringing”) the other party. For example, before a client inserts a Require header field into an INVITE listing an option that it is not certain the destination UAS supports, the client may query the destination UAS with an OPTIONS to determine whether this option is returned in a supported header field. In some embodiments, the Header fields in a request/response may contain information that indicate that the UA is bot-capable.

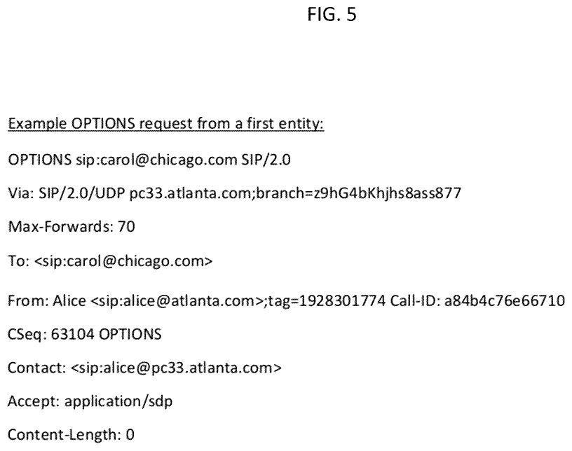

FIG. 5 contains an example of an OPTIONS request in Session Initiation Protocol that may be used by a first bot.

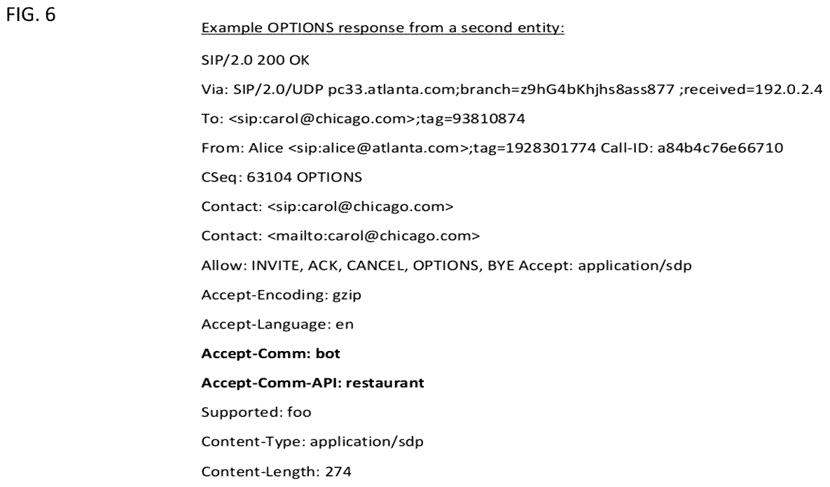

FIG. 6 contains an example of an OPTIONS response in Session Initiation Protocol that may be used by a second bot. According to this example, the telephony module of the first entity, upon receiving the OPTIONS response, may inform the bot module that the peer entity may use the API set “restaurant.” Thus, the bot module of the first entity may use the API set “restaurant” (if capable) to communicate with the second entity. For example, in some embodiments, for out-of-band-signaling, the bot module and the telephony module (e.g., SIP) local to an entity must communicate with each other. In this manner, they may collectively facilitate bot-to-bot communication with a peer entity.

In some implementations, application programming interface (API) calls may be used to enable the bot system to interact directly with the communication infrastructure to manage out-of-band signals. For example, during call setup using SIP, the calling bot could use the provided API to set a control message indicating its bot capabilities. Specifically, the bot system may call an API to modify the SIP INVITE header to include additional fields such as Accept-Comm (which may indicate that it accepts communication from another bot) and Accept-Comm-API (which may indicate the specific bot API set it supports).

Similarly, for receiving bots, the communication system may provide an API that detects out-of-band signals within incoming call setup messages. Upon receiving a SIP OPTIONS or INVITE request, the system may analyze the extended header fields and use an API to pass this information to the bot system. The receiving bot, upon detecting that the calling entity is a bot capable of using a specific API set, may adjust its interaction style accordingly (e.g., switching to bot-to-bot communication mode using the recognized API). Such approaches may enable the communication system to play an active role in facilitating bot-to-bot interactions, providing a standardized mechanism for advertising and detecting bot capabilities. This may thus enable smooth and efficient bot interactions, e.g., in environments in which different bot platforms or APIs interoperate.

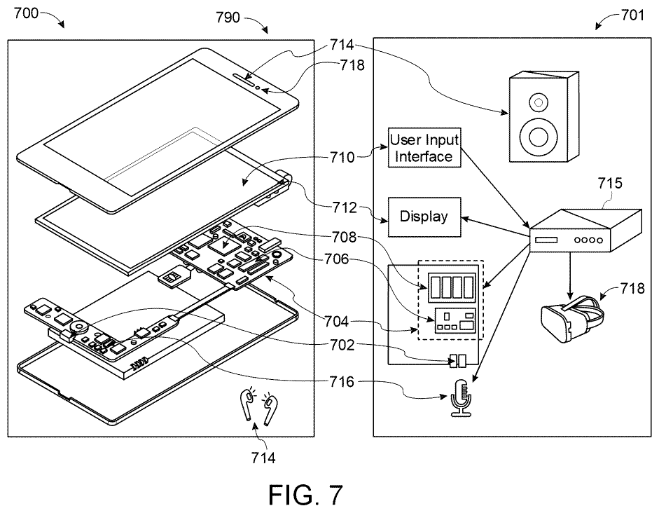

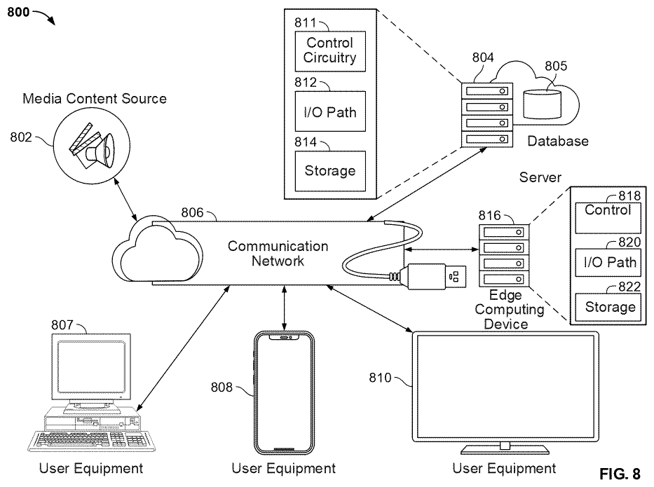

FIGS. 7-8 describe illustrative devices, systems, servers, and related hardware for virtual assistant communication, recognition, authentication and communication encryption. FIG. 7 shows generalized embodiments of illustrative user equipment devices 700 and 701, which may correspond to, e.g., computing devices 101, 103. For example, user equipment device 700 may be a smartphone device, a tablet, a virtual reality or augmented reality device, or any other suitable device capable of processing video data. In another example, user equipment device 701 may be a user television equipment system or device. User television equipment device 701 may include set-top bot 715. In some embodiments, display 712 may be a television display or a computer display. In some embodiments, set-top bot 715 may be communicatively connected to user input interface 710. In some embodiments, user input interface 710 may be a remote-control device. Set-top bot 715 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path.

Each one of user equipment device 700 and user equipment device 701 may receive content and data via input/output (I/O) path 702 that may comprise I/O circuitry (e.g., network card, or wireless transceiver). I/O path 702 may provide content (e.g., broadcast programming, on-demand programming, Internet content, content available over a local area network (LAN) or wide area network (WAN), and/or other content) and data to control circuitry 704, which may comprise processing circuitry 706 and storage 708. Control circuitry 704 may be used to send and receive commands, requests, and other suitable data using I/O path 502, which may comprise I/O circuitry. I/O path 702 may connect control circuitry 704 (and specifically processing circuitry 706) to one or more communications paths (described below). I/O functions may be provided by one or more of these communications paths, but are shown as a single path in FIG. 7 to avoid overcomplicating the drawing. While set-top bot 515 is shown in FIG. 8 for illustration, any suitable computing device having processing circuitry, control circuitry, and storage may be used in accordance with the present disclosure. For example, set-top bot 515 may be replaced by, or complemented by, a personal computer (e.g., a notebook, a laptop, a desktop), a smartphone (e.g., device 800), a tablet, a network-based server hosting a user-accessible client device, a non-user-owned device, any other suitable device, or any combination thereof.

Control circuitry 704 may be based on any suitable control circuitry such as processing circuitry 706. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i9 processors) or multiple different processors (e.g., an Intel Core i9 processor and an Intel Core i7 processor). In some embodiments, control circuitry 704 executes instructions for the AR application stored in memory (e.g., storage 708). Specifically, control circuitry 704 may be instructed by the AR application to perform the functions discussed above and below. In some implementations, processing or actions performed by control circuitry 704 may be based on instructions received from the application.

In client/server-based embodiments, control circuitry 704 may include communications circuitry suitable for communicating with a server or other networks or servers. The AR application may be a stand-alone application implemented on a device or a server. The AR application may be implemented as software or a set of executable instructions. The instructions for performing any of the embodiments discussed herein of the application may be encoded on non-transitory computer-readable media (e.g., a hard drive, random-access memory on a DRAM integrated circuit, read-only memory on a BLU-RAY disk, etc.). For example, in FIG. 7, the instructions may be stored in storage 708, and executed by control circuitry 704 of a device 700.

In some embodiments, the application for bot signaling and communication may be a client/server application where only the client application resides on device 700 (e.g., device 104), and a server application resides on an external server (e.g., server 804 and/or server 816). For example, the application may be implemented partially as a client application on control circuitry 704 of device 700 and partially on server 804 as a server application running on control circuitry 811. Server 804 may be a part of a local area network with one or more of devices 700 or may be part of a cloud computing environment accessed via the internet. In a cloud computing environment, various types of computing services for performing searches on the internet or informational databases, providing storage (e.g., for a database) or parsing data (e.g., using machine learning algorithms described above and below) are provided by a collection of network-accessible computing and storage resources (e.g., server 804 and/or edge computing device 816), referred to as “the cloud.” Device 800 may be a cloud client that relies on the cloud computing capabilities from server 804 to determine whether processing (e.g., at least a portion of virtual background processing and/or at least a portion of other processing tasks) should be offloaded from the mobile device, and facilitate such offloading. When executed by control circuitry of server 804 or 816, the AR application may instruct control 811 or 818 circuitry to perform processing tasks for the client device and facilitate the tasks herein described or provided therefor.

Control circuitry 704 may include communications circuitry suitable for communicating with a server, edge computing systems and devices, a table or database server, or other networks or servers The instructions for carrying out the above mentioned functionality may be stored on a server (which is described in more detail in connection with FIG. 8). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 8). In addition, communications circuitry may include circuitry that enables peer-to-peer communication of user equipment devices, or communication of user equipment devices in locations remote from each other (described in more detail below).

Memory may be an electronic storage device provided as storage 708 that is part of control circuitry 704. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 708 may be used to store various types of content described herein as well as AR application data described above (e.g., database 420). Nonvolatile memory may also be used (e.g., to launch a boot-up routine and other instructions). Cloud-based storage, described in relation to FIG. 7, may be used to supplement storage 708 or instead of storage 708.

Control circuitry 704 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 704 may also include scaler circuitry for upconverting and downconverting content into the preferred output format of user equipment 700. Control circuitry 704 may also include digital-to-analog converter circuitry and analog-to-digital converter circuitry for converting between digital and analog signals. The tuning and encoding circuitry may be used by user equipment device 700, 701 to receive and to display, to play, or to record content. The tuning and encoding circuitry may also be used to receive video AR generation data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to process simultaneous tuning functions (e.g., watch and record functions, picture-in-picture (PIP) functions, multiple-tuner recording, etc.). If storage 708 is provided as a separate device from user equipment device 700, the tuning and encoding circuitry (including multiple tuners) may be associated with storage 708.

Control circuitry 704 may receive instruction from a user by way of user input interface 710. User input interface 710 may be any suitable user interface, such as a remote control, mouse, trackball, keypad, keyboard, touch screen, touchpad, stylus input, joystick, voice recognition interface, or other user input interfaces. Display 512 may be provided as a stand-alone device or integrated with other elements of each one of user equipment device 700 and user equipment device 701. For example, display 512 may be a touchscreen or touch-sensitive display. In such circumstances, user input interface 710 may be integrated with or combined with display 712. In some embodiments, user input interface 710 includes a remote-control device having one or more microphones, buttons, keypads, any other components configured to receive user input or combinations thereof. For example, user input interface 710 may include a handheld remote-control device having an alphanumeric keypad and option buttons. In a further example, user input interface 710 may include a handheld remote-control device having a microphone and control circuitry configured to receive and identify voice commands and transmit information to set-top bot 715.

Audio output equipment 714 may be integrated with or combined with display 712. Display 712 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 712. Audio output equipment 714 may be provided as integrated with other elements of each one of device 700 and equipment 701 or may be stand-alone units. An audio component of videos and other content displayed on display 712 may be played through speakers (or headphones) of audio output equipment 714. In some embodiments, audio may be distributed to a receiver (not shown), which processes and outputs the audio via speakers of audio output equipment 514. In some embodiments, for example, control circuitry 704 is configured to provide audio cues to a user, or other audio feedback to a user, using speakers of audio output equipment 514. There may be a separate microphone 516 or audio output equipment 714 may include a microphone configured to receive audio input such as voice commands or speech. For example, a user may speak letters or words that are received by the microphone and converted to text by control circuitry 704. In a further example, a user may voice commands that are received by a microphone and recognized by control circuitry 704. AR display device 718 may be any suitable AR display device (e.g., an integrated head mountain display or AR display device connected to a system 700). In some embodiments all elements of system 700 may be places into housing of the AR display device 518. In some embodiments, AR display device 718 comprises a camera (or a camera array) 756. Video cameras 756 may be integrated with the equipment or externally connected. One or more of cameras 756 may be a digital camera comprising a charge-coupled device (CCD) and/or a complementary metal-oxide semiconductor (CMOS) image sensor. One or more of cameras 756 may be an analog camera that converts to digital images via a video card. In some embodiments, one or more of cameras 756 may be dirtied at outside physical environment (e.g., two cameras may be pointed out to capture to parallax views of the physical environment). In some embodiments, one or more of cameras 756 may be pointed at user's eyes to measure their rotation to be used as biometric sensors. In some embodiments, AR display device 518 may comprise other biometric sensor or sensors to measure eye rotation (e.g., electrodes to measure eye muscle contractions). AR display device 718 may also comprise range image 754 (e.g., LASER or LIDAR) for computing distance of devices by bouncing the light of the objects and measuring delay in return (e.g., using cameras 756). In some embodiments, AR display device 718 comprises left display 750, right display 750 (or both) for generating images.

One or more application whose functionality is described herein may be implemented using any suitable architecture. For example, such applications may be stand-alone applications wholly-implemented on each one of user equipment device 700 and user equipment device 701. In such an approach, instructions of the application may be stored locally (e.g., in storage 708), and data for use by the application is downloaded on a periodic basis (e.g., from an out-of-band feed, from an Internet resource, or using another suitable approach). Control circuitry 704 may retrieve instructions of the application from storage 708 and process the instructions to provide functionality and preform any of the actions discussed herein. Based on the processed instructions, control circuitry 704 may determine what action to perform when input is received from user input interface 710. For example, movement of a cursor on a display up/down may be indicated by the processed instructions when user input interface 710 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

In some embodiments, data for use by a thick or thin client implemented on each one of user equipment device 700 and user equipment device 701 may be retrieved on-demand by issuing requests to a server remote to each one of user equipment device 700 and user equipment device 701. For example, the remote server may store the instructions for the application in a storage device. The remote server may process the stored instructions using circuitry (e.g., control circuitry 704) and generate the signals or communication discussed above and below. The client device may receive the signals or communication generated by the remote server and may display the content of the displays locally on device 700. This way, the processing of the instructions is performed remotely by the server while the resulting displays (e.g., that may include text, a keyboard, or other visuals) are provided locally on device 700. Device 700 may receive inputs from the user via input interface 710 and transmit those inputs to the remote server for processing and generating the corresponding signals or communication. For example, device 700 may transmit a communication to the remote server indicating that an up/down button was selected via input interface 710. The remote server may process instructions in accordance with that input and generate a display of the application corresponding to the input (e.g., a display that moves a cursor up/down).

In some embodiments, an application whose functions are described herein may be downloaded and interpreted or otherwise run by an interpreter or virtual machine (run by control circuitry 704). In some embodiments, such an application may be encoded in the ETV Binary Interchange Format (EBIF), received by control circuitry 704 as part of a suitable feed, and interpreted by a user agent running on control circuitry 704. For example, the application may be an EBIF application. In some embodiments, the application may be defined by a series of JAVA-based files that are received and run by a local virtual machine or other suitable middleware executed by control circuitry 704. In some of such embodiments (e.g., those employing MPEG-2 or other digital media encoding schemes), the application may be, for example, encoded and transmitted in an MPEG-2 object carousel with the MPEG audio and video packets of a program.

FIG. 8 is a diagram of an illustrative system 800 for bot recognition, authentication and communication, in accordance with some embodiments of this disclosure. User equipment devices 807, 808, 810 (e.g., which may correspond to one or more of computing device 212 may be coupled to communication network 806. Communication network 806 may be one or more networks including the Internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 806) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 8 to avoid overcomplicating the drawing.

Although communications paths are not drawn between user equipment devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user equipment devices may also communicate with each other directly through an indirect path via communication network 806.

System 800 may comprise media content source 802, one or more servers 804, and one or more edge computing devices 816 (e.g., included as part of an edge computing system, such as, for example, managed by mobile operator 206). In some embodiments, the applications may be executed at one or more of control circuitry 811 of server 804 (and/or control circuitry of user equipment devices 807, 808, 810 and/or control circuitry 818 of edge computing device 816). In some embodiments, data structure 300 of FIG. 3, may be stored at database 805 maintained at or otherwise associated with server 804, and/or at storage 822 and/or at storage of one or more of user equipment devices 807, 808, 810.

In some embodiments, server 804 may include control circuitry 811 and storage 814 (e.g., RAM, ROM, Hard Disk, Removable Disk, etc.). Storage 814 may store one or more databases. Server 804 may also include an input/output path 812. I/O path 812 may provide generation data, device information, or other data, over a local area network (LAN) or wide area network (WAN), and/or other content and data to control circuitry 811, which may include processing circuitry, and storage 814. Control circuitry 811 may be used to send and receive commands, requests, and other suitable data using I/O path 812, which may comprise I/O circuitry. I/O path 812 may connect control circuitry 811 (and specifically control circuitry) to one or more communications paths.

Control circuitry 811 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 811 may be distributed across multiple separate processors or processing units, for example, multiple of the same type of processing units (e.g., two Intel Core i9 processors) or multiple different processors (e.g., an Intel Core i9 processor and an Intel Core i7 processor). In some embodiments, control circuitry 811 executes instructions for an emulation system application stored in memory (e.g., the storage 814). Memory may be an electronic storage device provided as storage 814 that is part of control circuitry 811.

Edge computing device 816 may comprise control circuitry 818, I/O path 820 and storage 822, which may be implemented in a similar manner as control circuitry 811, I/O path 812 and storage 824, respectively of server 804. Edge computing device 816 may be configured to be in communication with one or more of user equipment devices 807, 808, 810 and video server 804 over communication network 806, and may be configured to perform processing tasks (e.g., AR generation) in connection with ongoing processing of video data. In some embodiments, a plurality of edge computing devices 816 may be strategically located at various geographic locations, and may be mobile edge computing devices configured to provide processing support for mobile devices at various geographical regions.

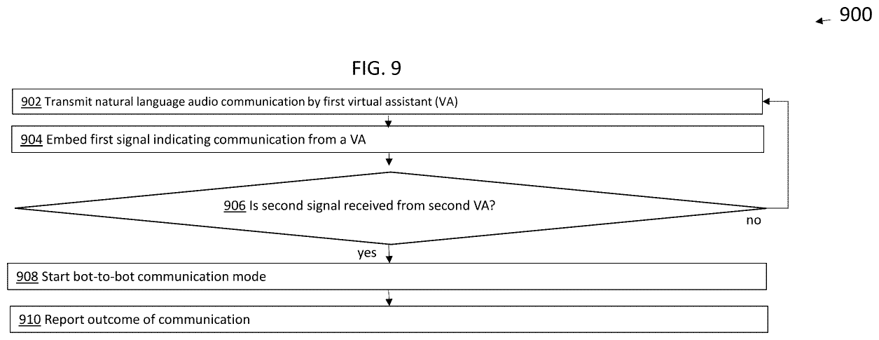

FIG. 9 is a flowchart illustrating an example of a process 900 for playing generated audio overlays by media player instances, according to an aspect of the present disclosure. One or more actions of the method 900 may be incorporated into or combined with one or more actions of any other process or embodiments described herein. These and other methods described herein, or portions thereof, may be saved to a memory or storage (e.g., of the systems shown in FIG. 7 or 8) or locally as one or more instructions or routines, which may be executed by any suitable device or system having access to the memory or storage to implement these methods.

At 902, the first VA 101 may transmit natural language audio communication to the second VA.

At 904, the first VA 101 may embed a first signal in the audio stream indicating that the first VA 101 is a bot and is ready for bot-to-bot communication.

At 906, the first VA 101 may wait for reception of a second signal from the second VA 103 indicating that it too is a bot. If no such second signal is received within a specified time, for example, withing 1-5 seconds, or within 0.1-30 seconds, then communication may continue using natural language human voice communication.

If such a second signal is received, then at 908, the first VA 101 may enter a bot-to-bot communication mode with the second VA 103.

At 910, the first VA 101 may report an outcome of the call with the second VA 103 to a device of the user and/or may store a record of the session to a server or locally. Such a report or record may include the date/time of the call, an identification of the node with which communication occurred, which bot initiated the request for bot-to-bot communication, what confidential communication was transmitted and/or received, and the like.

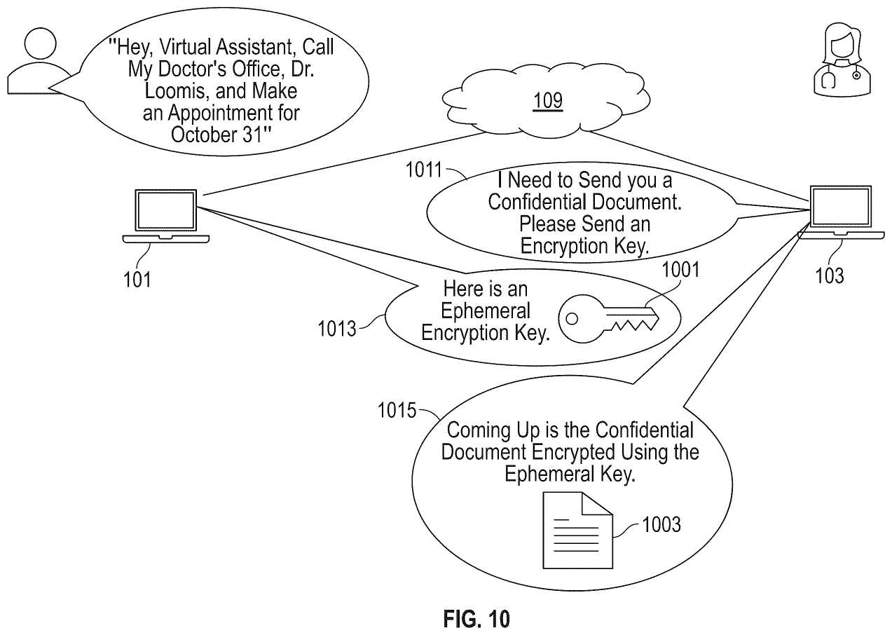

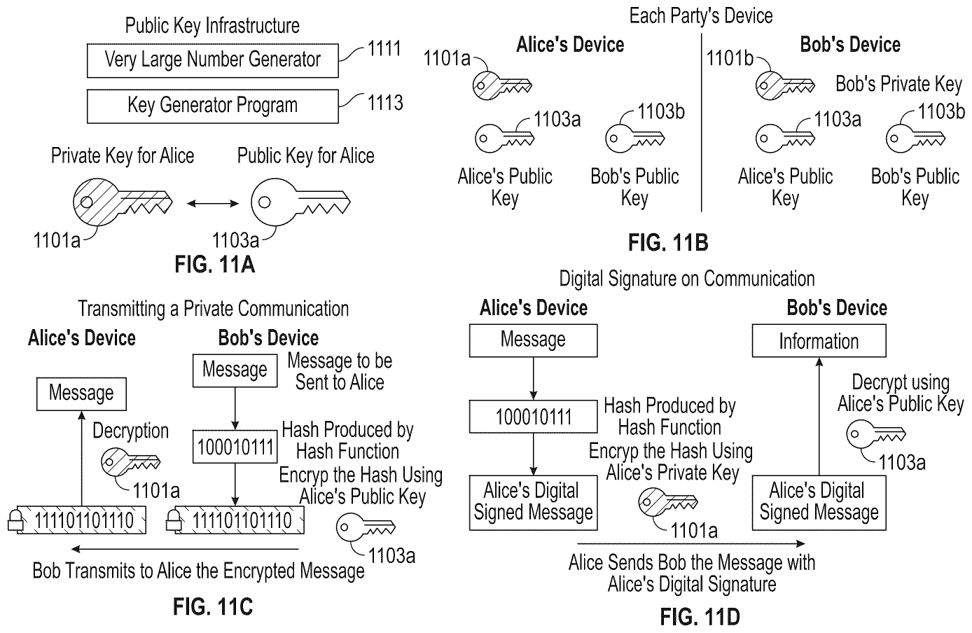

FIGS. 10 and 11 illustrates an embodiment in which virtual assistant 101 and virtual assistant 103 manage the transmission of confidential information, according to a further aspect of the disclosure.

When two digital voice assistants communicate with each other, they may have to share a user's private information to perform the task a user has instructed them to. For example, a user may ask their digital assistant to call their doctor to make an appointment. The user's digital assistant may then reach the doctor's office and be communicating with the receptionist virtual voice assistant, which may request the sharing of Personally Identifiable Information (PII) of the user.

Users may be unaware of how PII or other confidential information is shared among bots, including among AI chatbots. Managing user consent becomes more complex when data flows across multiple systems. In addition, regulations like GDPR, CCPA, HIPAA and others mandate strict data protection and transparency. Ensuring compliance across multiple systems is challenging, e.g., when different systems are subject to different regulatory requirements.

For instance, a user based in Europe, a GDPR jurisdiction, may ask their digital assistant to call an airline to book a flight. The airline bot may be located in the US and ask for PII to book the flight without the user interaction or explicit consent. The user's voice assistant may be provided by a US company and the data flow between the two bots may hence be happening within US borders and may not consider the export of the PII data as protected by European regulations. A malicious bot may call and impersonate a business or one of the user's connections (human or their associated voice assistant). Without authentication, the user's digital assistant may share PII with the malicious bot. In another example, a bot may be interacting with another bot and share private information which is then communicated to a third bot without proper user consent. In some other instance a user may set up a malicious voice assistant (with or without their knowledge) to answer calls. This may be a work assistant to discuss contracts with a customer, for example. When a customer reaches out to the user, the malicious assistant may extract private or protected information from the customer and use it for nefarious purposes.

As shown in FIG. 10, a digital voice assistant may be in communication with another digital voice assistant. A user may ask his or her voice assistant, for example, to “Call Dr. Loomis and make an appointment for October 3first.”

As shown in FIG. 10, making the appointment may entail disclosing the name of the patient and their date of birth. A user disclosing private information to a bot, or a bot disclosing private information on behalf of a user who has provided consent is fine, but when two bots have to exchange private information, additional guardrails may be provided to ensure that the information is adequately protected. For example, a bot may inform a caller bot that the conversation may be recorded (as it would to a human caller). In that case, the caller bot does not disclose information to the second virtual assistant in the open because consent for sharing information and recording information has not been obtained from the human user on behalf of whom the caller bot is conversing with the other bot.

The first virtual assistant 101 may identify that it is in communication with another bot, as discussed in the foregoing description. Upon detecting that it is interacting with the second bot, as shown at 1011 it may inform the first virtual assistant that confidential information is being sent. This may be an implicit request or suggestion for the virtual assistant to send an encryption key, or the second virtual assistant may explicitly request the encryption key. This communication and the communication that follows may entail bot-to-bot communication. In FIG. 10 and in some others, the lack of quotation marks for sentences may indicate that the communication is bot-to-bot communication signifying what is illustrated in the figure as English language sentences.

At 1013, the first virtual assistant 101 may transmit to the second virtual assistant an ephemeral encryption key 1001 that the second virtual assistant 103 may use to secure aspects of the conversation. The second digital voice assistant may identify personal and non-personal information to perform the tasks and to exchange the personal information, such as lab results, medical images or doctor's messages for the user, with the first digital voice assistant, it may use the ephemeral encryption key it receives while establishing the mutual bot recognition handshake to encrypt the private information of the user during the voice conversation with the second digital voice assistant.

An ephemeral key may be generated for each encryption use but also may be used more than once, for example, for encryption of multiple documents within a single communication session. An ephemeral key may be a public encryption key. The second virtual assistant 103 may encrypt the confidential document and, at 1015, the second virtual assistant may transmit the confidential document 1003 encrypted using the ephemeral encryption key 1001 to the first virtual assistant 101.

As shown in FIG. 11A, in the public key-private key scheme, a large random number generator may be used to generate a number, which is used to generate a pair of keys: a private key and a public key. The private key is known only to the actor to whom it belongs while the public key is transmitted to another party or published and may become known by anyone. Each party's device has a private key and one or more public keys for communicating with other nodes.

As shown in FIG. 11B, Alice's device has a private key known only to Alice and also has one or more public keys that are stored or obtained, which are used to communicate securely with Bob and other nodes. Similarly, Bob's device has a private key known only to Bob and one or more public keys for Alice as well as other public keys for other nodes. Public keys of other nodes may be obtained by each node from the public-private key infrastructure.

As shown in FIG. 11C, Bob may send Alice a private message by first encrypting a hash of the intended message using the public key of Alice. Alice receives the encrypted message and uses her private key to decrypt the message that had been encrypted by Bob using Alice's corresponding public key. Thus, if the message is intercepted, it may be decrypted only using Alice's private key.

Using such an approach, the first virtual assistant 101 may transmit an ephemeral encryption key 1001 to the second virtual assistant 103. The second virtual assistant 101 may use the ephemeral encryption key 1001 to encrypt one or more confidential documents or images, and at 1015 the second virtual assistant 103 may transmit the encrypted confidential document(s) or image(s) to the first virtual assistant 101.

The ephemeral encryption key 1001 and/or the encrypted document may be transmitted in baseband audio and may be separate from telephone encryption that can take place such as with systems using VoIP, such as using protocols like Secure Real time Transport Protocol (SRTP) or ZRTP to encrypt audio packets during transmission, securing the conversation end to end.

One or more of several techniques may be used to secure private information. Some examples are noted below; however, this is not an exclusive list of the techniques contemplated:

Analog scrambling may be used to encode the private information. This technique distorts the audio signal by scrambling its frequency or phase before transmission, making it unintelligible without a specific descrambler at the receiving end.

Frequency inversion and split band scrambling may be used in analog scrambling. A rolling code may be based off the ephemeral encryption key 1001 received from the bot to secure personal information during the call.

Digital encryption approaches may be used to secure the personal information exchanged with the second bot. The personal information may be in a textual form, encrypted using the ephemeral encryption key 1001 and converted into a PCM stream that is used to generate an audio.

The ephemeral encryption key may be watermarked into the conversation. Instead of sharing private information using voice, a digital voice assistant may generate a set of secrets and embed the encrypted personal information using audio watermark techniques. The secret may be registered in advance with the receiving virtual assistant so that it may decrypt the message or document using the previously registered secrets.

The bot may add audible markers to indicate that the next portion of the communication, such as the immediately following portion of communication, will include private information and will be encrypted accordingly. During the bot-to-bot handshake, both bots may agree on a method to encrypt, a set of audible markers, a method of private information communication and a set of encryption keys. Each bot may repeat the confidential information or document back to the bot that first transmitted it and hence may encrypt and transmit the confidential information accordingly also using an ephemeral encryption key. In addition, the bot that received the ephemeral encryption key 1001 may transmit a second ephemeral encryption key so that it may receive confidential information.

A request of an ephemeral encryption key may be transmitted from bot-to-bot for each disclosure—a new ephemeral encryption key may be requested each time for every confidential document or piece of information. Or a single ephemeral encryption key may be exchanged at the beginning of the bot exchange and used to secure all private information transmissions from one bot to another. In another example, the request of an encryption key may be contingent on the private information being protected: the same key may be re used to decrypt the same private information. Or, some types of highly confidential information, such as patient records, may encrypted using an encryption key different from another encryption key that may be used for the other confidential information transmitted during the other portions of the conversation.

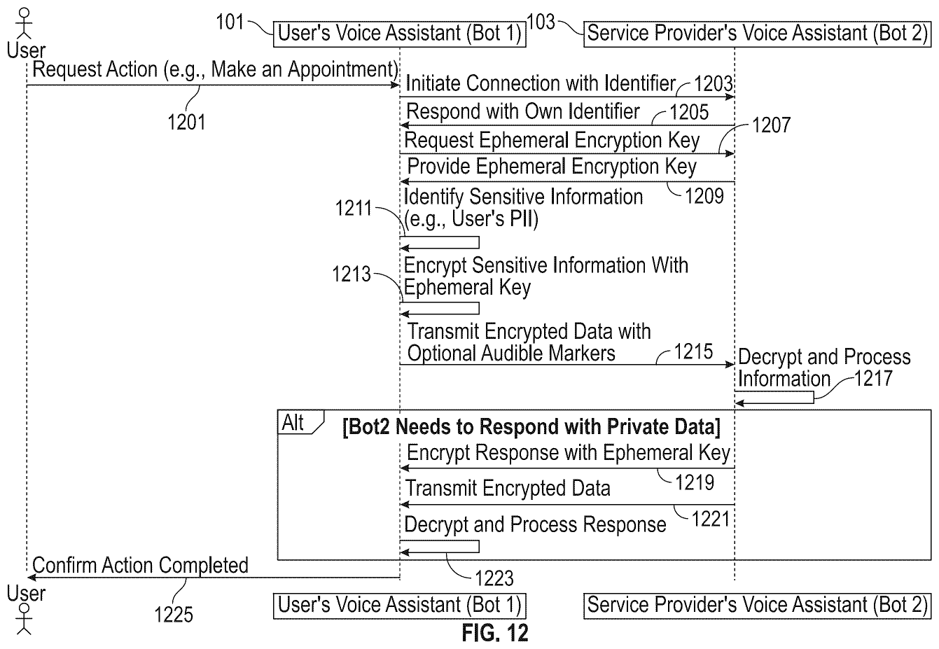

FIG. 12 illustrates an example of a communication process between the first and second virtual assistants processing confidential communication.

As shown at 1201, a user may request the first virtual assistant 101 to make a telephone call, for example, to make an appointment. At 1203, the first virtual assistant 101 may identify itself as a bot and may identify itself as being associated with a particular user or user account. At 1205, the second virtual assistant 103 may identify itself as a bot and may identify a particular node with which is affiliated. For example, it may identify itself as being a customer service representative of the office called by the first virtual assistant 101.

At 1207 the first virtual assistant 101 may request an ephemeral encryption key 1007 from the second virtual assistant 103. At 1209, the second virtual assistant 103 may transmit the ephemeral encryption key 1001 to the first virtual assistant 101. The first virtual assistant 101, at 1211, may identify the confidential information and may encrypt the confidential information using the ephemeral encryption key at 1213. At 1215, the first virtual assistant 101 may then transmit the confidential data encrypted using the ephemeral encryption key 1001 to the second virtual assistant 103.

The second virtual assistant 103 may also transmit confidential information to the first virtual assistant 101. At 1219, the second virtual assistant 103 may encrypt a response with confidential information using an ephemeral encryption key that it had received.

At 1221 the information the confidential information encrypted using the ephemeral encryption key transmitted by second virtual assistant 103 to first virtual assistant 101. At 1223, the first virtual assistant decrypts the received confidential information. At 1225 the first virtual assistant 101 may inform the user that the requested action has been completed.

According to another aspect of the disclosure, a user account is previously registered with another node, such as a business that uses a digital voice assistant to service their customers. For example, the user may have registered with a doctor's office and authorized it to use the office's customer service digital voice assistant to provide private information such as medical records or results of medical tests pertaining to the user. During a registration phase, the user node may be requested to provide, or may be assigned, secrets that later in the course of a call may be used to authenticate the user as a caller when using a digital voice assistant. For example, the user may be asked to enter a set of challenge/response pairs. Or a set of challenge/response pairs may be generated by the registration process automatically.

The challenge/response pair may consist of randomly chosen words or may consist of word associations, such as “cat/dog” meaning that when one of the bots issues the request by voicing the word “cat”, the other bot should answer with the word “dog” to signal it is the appropriate party. While sometimes described as a word or secret, the challenge secret and/or the response secret may each comprise a complex string of alphanumeric characters or other symbols and spaces. One or both of the challenge secret and/or the response secret may include out-of-band communication of one or more of the types described herein and/or may include in-band tone sequences.

Having registered the challenge/response pairs of secrets, the user node using the first virtual assistant 101 and the second node (e.g., the medical office) using the second virtual assistant 103 have a trusted method to communicate and can share personal information pertaining to the user.

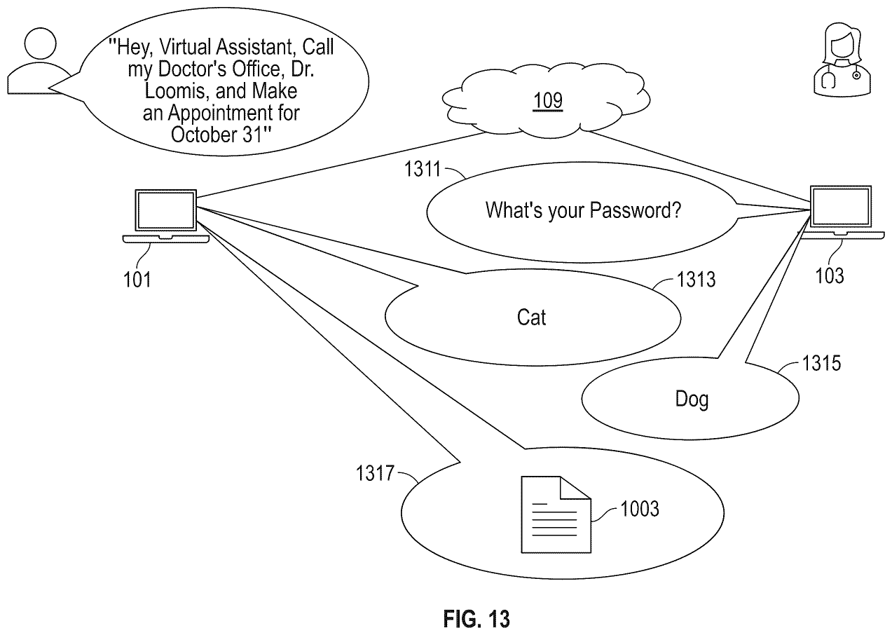

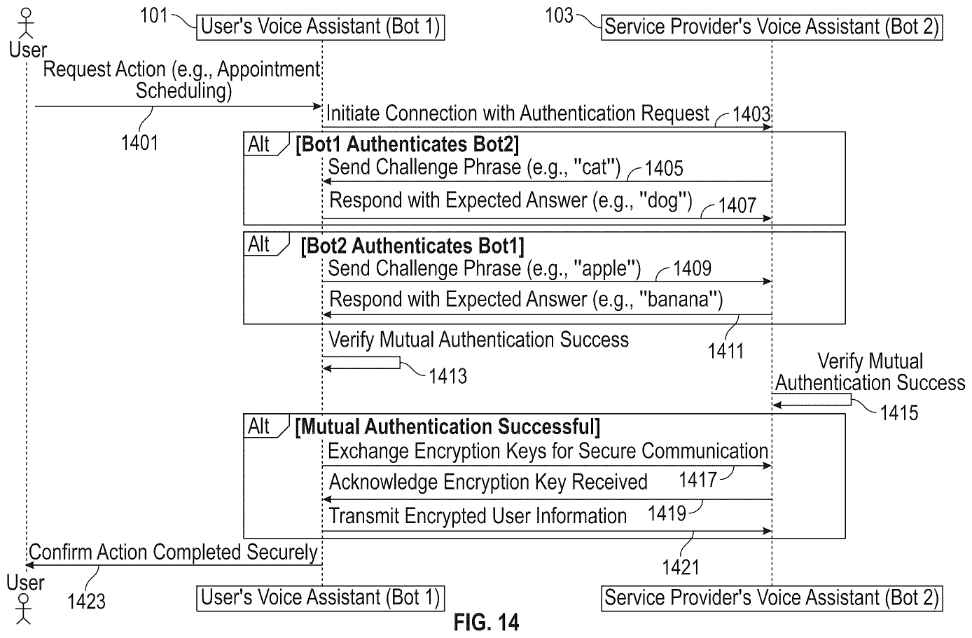

FIG. 13 illustrates an authentication process for bot-to-bot authentication. The bots may communicate using ordinary human voice communication or may first establish bot-to-bot communication.

A user may request that the first virtual assistant 101 contact someone, illustrated here by way of example as a request to schedule an appointment with Dr. Loomis on October 31. At 3011, the second virtual assistant 103 may request the first virtual assistant 101 to provide a secret. The secrets, including the challenge secret and the response secret, may be registered in advance with each bot.

At 1313, the first bot 101 may provide the challenge secret, in this illustration “cat.” At 1315, the second virtual assistant 103 may respond with the response secret, in this illustration “dog.” Based on the mutual authentication of the bots, confidential information may be exchanged and, at 1317, the first virtual assistant 101 may transmit confidential information, such as a confidential document 1003, to the second virtual assistant 103. In an implementation, the authentication may entail more than a single cycle of the challenge secret and/or the response secret: following the receipt of the response secret, the bot that had transmitted the challenge secret may be requested or be expected to transmit a further secret. In addition, the bot that had transmitted the response secret may be requested or expected to transmit a further secret. In some embodiments, bots may use a form of zero-knowledge proof (ZKP) for authentication so that the actual secrets are never “spoken” in the open. ZKP is a cryptography technique in which one party (the prover) can convince another party (the verifier) that the one party knows the secret without explicitly conveying to the verifier any information that reveals the secret. For example if the secret is “10 ft red soccer ball,” the challenge may be “what shape is the secret” (acceptable answer: round) and “what size is the secret” (acceptable answer: huge).

In another embodiment, two bots communicating with each other may have established that they are bots and that they are to share private information pertaining to a user associated with either one of the two bots do not have the proper authorization to do so or have been configured to require confirmation from the user before sharing private information with another bot system. A user may have authorized their first digital voice assistant to share private information with a limited number of other second digital voice assistants. When a call comes from a digital voice assistant that the first digital voice assistant does not recognize as part of the authorized second voice assistants, it may require confirmation from the user to share private information with that second voice assistant. An illustrative malicious scenario would be for a user to instruct their voice assistant to answer their doctor's office calls. Upon receiving a call from a malicious bot masquerading as the user's doctor's office, the user's voice assistant may identify the calling bot as new by for instance applying the method described in the previous section of this disclosure or by simply detected a different call number and upon being requested by the malicious bot to provide the user's private information, ask for the user's input prior to do so.

The voice assistant may generate a text message to a smartphone or generate a request to an authentication application or generate a new voice call to the user's smartphone to ask for confirmation. In another example, the user's digital voice assistant may put the second virtual assistant on hold and hand over the call to the user to authorize the sharing of private information. The user's digital voice assistant may identify the reason an authorization request is provided so that the user knows that the bot on the other end of the line is not in the list of trusted entities the user may have authorized in the past.

A further process for bot-to-bot authentication is shown in FIG. 14. At 1401, user may request that the user's bot, first virtual assistant 101, take an action to contact someone. At 1403, the first virtual assistant 101 may initiate a connection with the second virtual assistant 103. The bots may identify each other as bots, for example, using the signaling above described, and then continue using bot-to-bot communication. In an implementation, the bots may continue to use ordinary human voice communication.

At 1405, the second virtual assistant 103 may transmit a secret, sometimes referred to as a challenge phrase or challenge word, to the first virtual assistant 101. The first virtual assistant 103, at 1407, may respond with a response secret, transmitted to the second virtual assistant 103. Or, as shown at 1409, the first virtual assistant 101 may transmit the challenge secret and the second virtual assistant 103 may reply with the response secret. In some embodiments, authentication of (e.g., only) one of the bots is provided. For example, the authenticated bot is requesting confidential information or the authenticated bot is receiving confidential information.

At 1413, the first virtual assistant 101 determines that the second virtual assistant 103 has been authenticated. her, and the authentication may be complete. At 1415 the second virtual assistant 103 determines that the authentication of the first virtual assistant 101 is successful.

An additional set of steps may be taken ensure security of confidential of information. At 1417, the first virtual assistant 101 transmit an encryption keys to establish secure communication with the second virtual assistant 103. At 419, the second virtual assistant 103 may acknowledge receipt of the encryption key. Based on this the first virtual assistant 101, at 1421, may transmit encrypted confidential information to the second virtual assistant 103.

At 1423, the first virtual assistant 101 may report to user details about the communication session with the second virtual assistant 103, including the date/time of the call, the fact that it had been communicating with a bot, details about the bot, the authentication technique used, and the confidential information that it sent and/or the confidential information that it received.

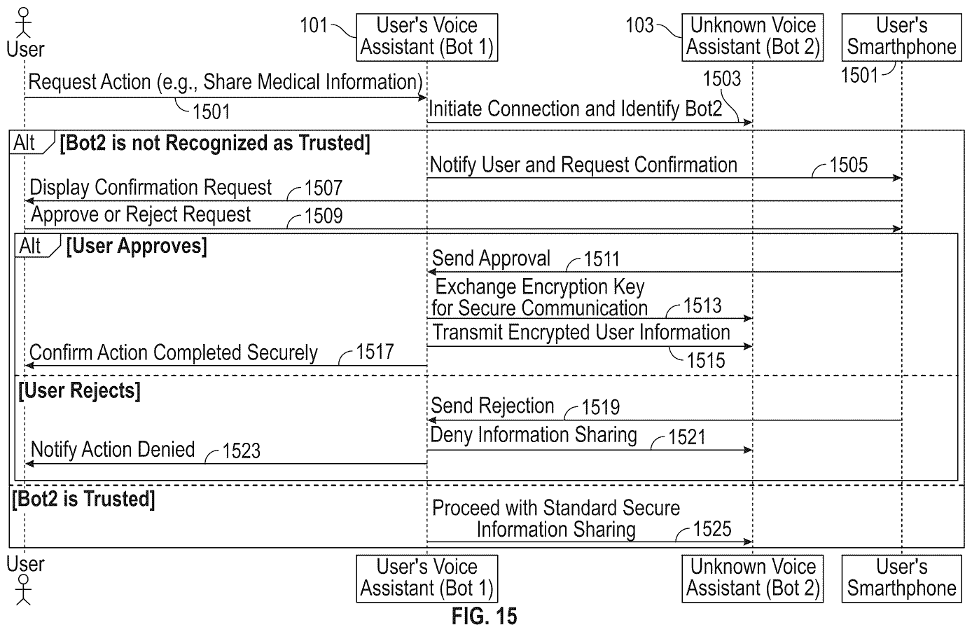

FIG. 15 illustrates an implementation in which a bot may be authenticated using communication with a third-party, such as a user's device 107.

At 1501, a user may request that the first virtual assistant 101 provide medical information to a second virtual assistant 103. At 1503, the first virtual assistant 101 may initiate communication with the second virtual assistant 103 based on the user request at 1501. Each bot may determine that it is communicating with a second bot, not a human, and may continue the communication session using a bot-to-bot communication mode, as described herein. Or the bots may continue communication using ordinary human voice communication.

At 1505, the first virtual assistant 101 may notify the user device 107 of the request, and request confirmation for communicating with the second virtual assistant 103. For example, the first virtual assistant 101 may provide the telephone number that it has dialed or provide other information about the node associated with the second virtual assistant 103 that has answered the call. The first virtual assistant 101 may provide a caller ID information that it has received about the node associated with the second bat 103 to the user's device 107.

At 1507, the user device may display the confirmation request to the user and, at 1509, user may approve or reject the request to authenticate the second virtual assistant 103. Based on the user's approval, processing moves to 1511, where the user's device 107 transmits approval of authentication to first virtual assistant 101.

The first virtual assistant 101 may request an encryption key, such as an ephemeral encryption key from the second virtual assistant 103, at 1513. In response, the second virtual assistant 103 may transmit the encryption key. At 1515, the first virtual assistant 101 may transmit encrypted confidential information to the second virtual assistant 103 encrypted using the encryption key.

At 1517 the first virtual assistant 101 one may confirm to the user that it has provided the confidential information.

On the other hand, if the user at 1509 rejects authentication of the second 103, then at 1519 the user's device 107 may send to the first virtual assistant 101 a rejection of the request for authentication. Based on this rejection at 1519, the first virtual assistant 101 may inform the second virtual assistant 103 that it is denying the sharing of information, or may simply refuse to provide information or may disconnect the call.

At 1523, the first virtual assistant 101 may notify the user of the action it has taken. At 1525, the first virtual assistant 101 may continue with a standard secure information sharing. In an implementation, this may be done even if the user had disapproved of the sharing of the highly confidential information with the second virtual assistant 103.

In an implementation, one or both of the bots may be authenticated using a cryptographic signature of the bot or of the node with which the bot is associated. As shown in

As shown in FIG. 11D the private key-public key system may also be used for digital signatures for documents. For example, Alice may send Bob a message by first using Alice's private key to sign the message. Such a message would be guaranteed to have come from Alice because only Alice has Alice's private key. Alice's public key would decrypt the message. Anyone can obtain Alice's public key and may decrypt the message using Alice's public key. However, Alice's public key is known to be associated with Alice and with Alice's private key. For example, any communication that can be decrypted using Alice's public key must have been encrypted by Alice's private key, and Alice's private key is known only to Alice. Therefore, any receiving party that is able to decrypt the communication using Alice's public key would have some assurance that the message was from Alice because of the use of Alice's digital signature for the message provided using Alice's private key.

Using such an approach, a bot may be requested to authenticate itself by encrypting a communication using its private key (or the private key of the node, such as the doctor's office or of the user) with which it is associated. If the public key of that bot is able to decrypt the encrypted communication, then this may be a basis for authenticating the bot.

In an additional implementation, if a bot system can have direct access to the communication layer, such as the telephony system or the signaling protocol, which manages call setup and teardown, then the bot system does not embed the ephemeral key (used to encrypt and protect PII) in the audio baseband. Out-of-band signaling may be used to provide this key. Out-of-band signaling may operate in the control plane of the communication system, separate from the main audio communication (the media plane), allowing the bot systems to exchange identification and capability information before or during the call setup. By way of example, SIP may be used to establish and to teardown VoIP audio calls. A SIP client (UAC User agent client) uses an INVITE message that contains Header fields to initiate a call to another end point (UAS User Agent Server) that establishes a route via SIP proxies.

Authentication information is embedded in the Authorization Header field by the UAC. When a UAS receives a request from a UAC, the UAS may authenticate the originator before the request is processed. If no credentials (in the Authorization header field) are provided in the request, the UAS can challenge the originator to provide credentials by rejecting the request with a 401 (Unauthorized) status code.

The authorization field value may include credentials containing authentication information of the UA for resource being requested as well as parameters required in support of authentication and replay protection. In an implementation, an ephemeral key used for encrypting PII in the audio baseband is delivered by the bot system on the client (calling party) to the SIP module, e.g., the UAC. This may be included as metadata in the Authorization Header. When the UAC is authenticated by the UAS, the UAS passes this ephemeral key to the co-located bot system for its use in decryption of the confidential information.

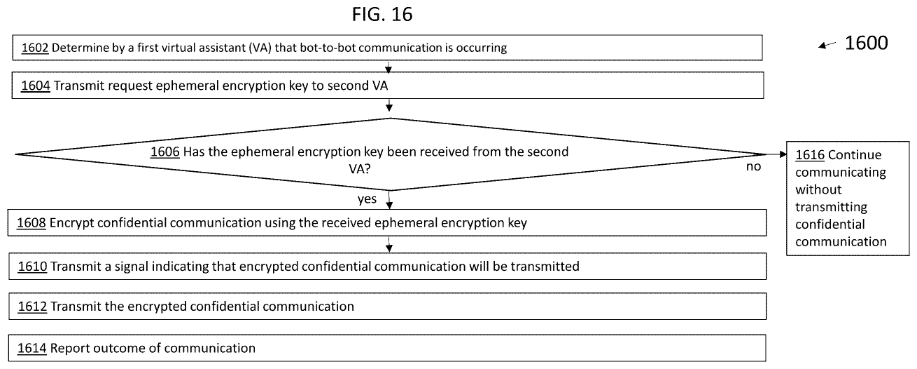

FIG. 16 is a flowchart illustrating an example of a process 1600 for encryption of confidential information, according to an aspect of the present disclosure. One or more actions of the method 900 may be incorporated into or combined with one or more actions of any other process or embodiments described herein. These and other methods described herein, or portions thereof, may be saved to a memory or storage (e.g., of the systems shown in FIG. 7 or 8) or locally as one or more instructions or routines, which may be executed by any suitable device or system having access to the memory or storage to implement these methods.

At 1602, the first VA 101 may determine that bot-to-bot communication is occurring.

At 1604, the first VA 101 may transmit a request for an ephemeral encryption key to the second VA.

At 1606, the first VA 101 may determine whether the ephemeral encryption key has been received from the second VA 103.

If it has not received, then at 1616, the first VA 101 may continue communication with the second bot 103 but without transmitting confidential communication.

If the ephemeral encryption key has been received, then at 1608, the first VA 101 may encrypt confidential communication using the received ephemeral encryption key and, at 1610 may transmit an indication that the encrypt confidential communication is about to be transmitted. This may alert the second VA 103 to initiate detection for the encrypt confidential communication.

At 1612, the first VA 101 may transmit the encrypt confidential communication.

At 1614, the first VA 101 may report an outcome of the call with the second VA 103 to a device of the user and/or may store a record of the session to a server or locally. Such a report or record may include the date/time of the call, an identification of the node with which communication occurred, which bot initiated the request for bot-to-bot communication, what confidential communication was transmitted and/or received, and the like.

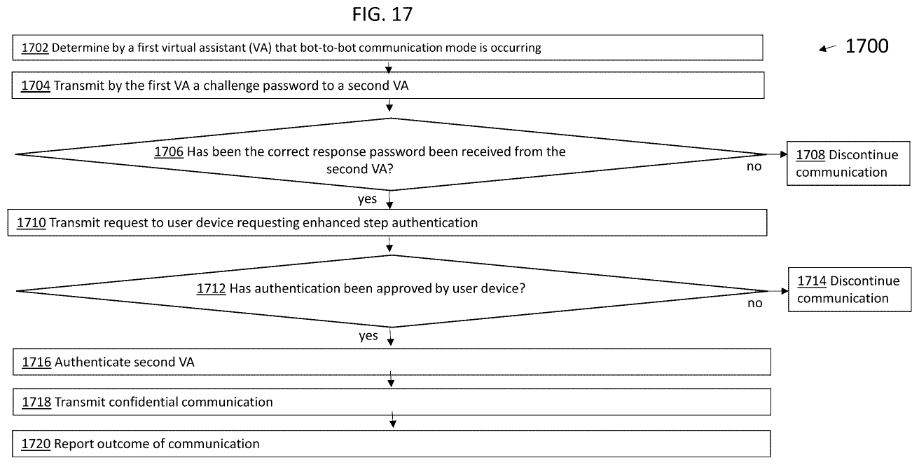

FIG. 17 is a flowchart illustrating an example of a process 1700 for playing generated audio overlays by media player instances, according to an aspect of the present disclosure. One or more actions of the method 900 may be incorporated into or combined with one or more actions of any other process or embodiments described herein. These and other methods described herein, or portions thereof, may be saved to a memory or storage (e.g., of the systems shown in FIG. 7 or 8) or locally as one or more instructions or routines, which may be executed by any suitable device or system having access to the memory or storage to implement these methods.

At 1702, the first VA 101 may determine that bot-to-bot communication is occurring.

At 1704, the first VA 101 may transmit a challenge secret to the second VA. The challenge secret and/or other secret may be embedded as a first signal in the audio stream using one or more of the techniques described herein.

At 1706, the first VA 101 may determine whether the correct response secret been received from the second VA 103. The secrets may be stored in both bots in advance as part of a registration by user or as part of an automated registration process in which the user instructs the virtual assistant to register secrets with all user contacts.

If the correct secret is not received, then at 1708, the first VA 101 may discontinue communication with the second bot 103. In addition, the first VA 101 may inform the user device, report to third party server or to other parties that an unauthorized call has been attempted. The first VA 101 may set a timer, for example, to 1-3 seconds, or 0.1-90 seconds, within which the response secret must be received for authenticating the second VA 103.

If the correct secret is received, then at 1710, the first VA 101 may transmit a request to user device requesting enhanced step authentication.

If the request is denied or user approval is not received from the user device within a prespecified time frame, for example, within 30 seconds to 2 minutes, or 10 second to 10 minutes, then at 1708, the call may be discontinued. In an implementation, the user device may have pre-installed a list of contact that are to be automatically authenticated when requested, or with which confidential information may be shared.

If at 1712 the user approval is timely received from the user device, then at 1716, the second VA is authenticated.

At 1718, the first VA 101 may transmit confidential information to the second VA 103 based on the authentication or, depending on the implementation, may at least continue the call with the second VA 103. In some implementations, in addition to authentication of the second VA 103, or without authentication of the second VA, confidential information may be shared in an encrypted version, as discussed herein.

At 1720, the first VA 101 may report an outcome of the call with the second VA 103 to a device of the user and/or may store a record of the session to a server or locally. Such a report or record may include the date/time of the call, an identification of the node with which communication occurred, which bot initiated the request for bot-to-bot communication, what confidential communication was transmitted and/or received, and the like.

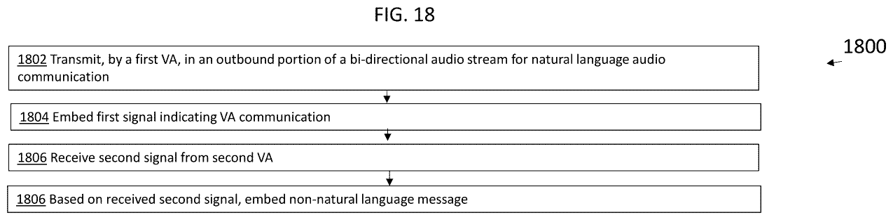

FIG. 18 is a flowchart illustrating an example of a process for entering a bot-to-bot communication mode, according to an embodiment.

At 1802, a first VA may be communicating using a bi-directional audio stream for natural language audio communication (e.g., VoIP). This may occur with or without prior human participation in the communication.

At 1804, the first VA may insert a first signal into an outbound channel of the bi-directional audio stream. The first VA may be the party that initiated the call using the bi-directional audio stream for natural language audio communication or the first VA may have answered the call from the second VA.

At 1806, the first VA may receive a second signal from the second VA. The first VA may determine that the second signal indicates that the second VA is also a VA. In an implementation, the second signal may identify the second VA as being associated with an account, second user profile or node. For example, the second signal may have been previously registered with the first VA as being associated with the account, second user profile or node. According to this implementation, the first VA may authenticate the second VA based on this second signal. Based on this, at 1806, the first VA may send a non-natural language message.

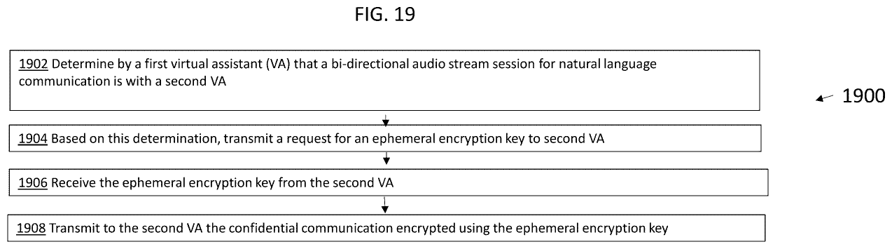

FIG. 19 is a flowchart illustrating an example of confidential information processing according to an embodiment.

At 1902, a first VA may determine that a bi-directional audio stream session for natural language communication is with a second VA. For example, this may be determined in one or more of the ways described above.

At 1904, based on this determination, the first VA may transmit a request for an ephemeral encryption key to the second VA. In some embodiments, the ephemeral encryption key may be transmitted after it is determined that both parties in a call are VAs without a request for the ephemeral encryption key to the second VA.

At 1906, the ephemeral encryption key may be received from the second VA.

The first VA, at 1908, may then encrypt confidential information using the ephemeral encryption key and send the encrypted confidential information to the second VA.

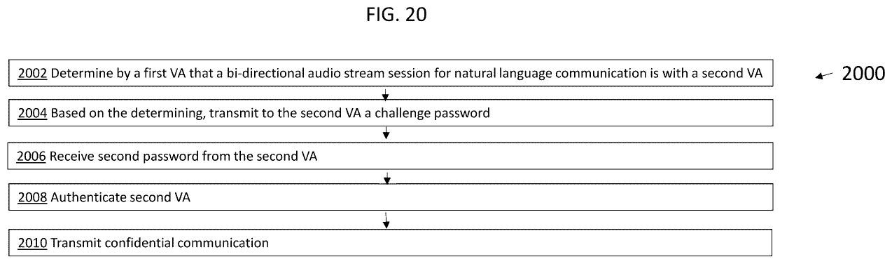

FIG. 20 is a flowchart illustrating an example of VA authentication according to an embodiment.

At 2002, a first VA may determine that a bi-directional audio stream session for natural language communication is with a second VA.

At 2004, the first VA may, based on the determining, transmit to the second VA a challenge secret. The challenge secret may be registered with the second VA prior to the present call session.

At 2006, the first VA may receive a second secret from the second VA. The second secret may be a response secret registered with the first VA prior to the present call session.

At 2008, the first VA may authenticate the second VA based on the received second secret. The first VA may transmit confidential information to the second VA after authentication. In an embodiment, the second VA may transmit confidential information to the first VA even after just receiving the challenge secret from the first VA. In an embodiment, the authentication process may be used to determine whether to continue communication with the second VA. In an embodiment, no confidential information may be transmitted to the second VA.

In an implementation, the bot-to-bot communication may be part of a video conference session with an audio data stream. In such an implementation, closed captioning or other textual information may be generated for the communication so that a human user may follow the communication and/or a transcript thereof may be displayed or be stored.

One or more additional audio time slots of the media asset may be processed in a similar manner. For example, a second audio time slot of the media asset may have a second original audio content that may be replaced with a generated audio overlay according to metadata of the media asset or according to metadata of the second original audio content. Metadata may be associated with a time slot of the media asset or with default audio content. For example, the media asset may comprise no default or original audio content for one or more time slots of a media asset. Metadata pertaining to the time slot may describe the audio overlay that is to be generated for the time slot, a repetition parameter for the audio overlay for the time slot and the like. A second media player instance may be accessed in the media player pool or may be instantiated for playing a second alternative audio overlay for the second time slot of the media asset.

The term “and/or,” may be understood to mean “either or both” of the elements thus indicated. Additional elements may optionally be present unless excluded by the context. Terms such as “first,” “second,” “third” in the claims referring to a structure, module or step should not necessarily be construed to mean precedence or temporal order but are generally intended to distinguish between claim elements.

Unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

The above-described embodiments are intended to be examples only. Components or processes described as separate may be combined or combined in ways other than as described, and components or processes described as being together or as integrated may be provided separately. Steps or processes described as being performed in a particular order may be re-ordered or recombined.

The interfaces, processes, and analysis described may, in some embodiments, be performed by an application. The application may be loaded directly onto each device of any of the systems described or may be stored in a remote server or any memory and processing circuitry accessible to each device in the system. The generation of interfaces and analysis there-behind may be performed at a receiving device, a sending device, or some device or processor therebetween.

Any use of a phrase such as “in some embodiments” or the like with reference to a feature is not intended to link the feature to another feature described using the same or a similar phrase. Any and all embodiments disclosed herein are combinable or separately practiced as appropriate. Absence of the phrase “in some embodiments” does not imply that the feature is necessary. Inclusion of the phrase “in some embodiments” does not imply that the feature is not applicable to other embodiments or even all embodiments. Throughout the specification, the phrases “in response to” and “based on” shall be understood to have a broad meaning unless context requires otherwise. For example, “in response to” may refer to a step that is in direct or indirect response to a prior step, and “based on” may refer to a step that is based at least in part on a prior step or on another factor.

Features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time.

The systems and/or methods described above may be applied to, or used in accordance with, other systems and/or methods. In various embodiments, additional elements may be included, some elements may be removed, and/or elements may be arranged differently from what is shown. Alterations, modifications, combination, and variations may be made to the particular embodiments by those of skill in the art without departing from the scope of the present application, which is defined solely by the claims appended hereto.

1. A method comprising:
embedding, by a first virtual assistant (VA), a first signal within an outbound portion of a bi-directional audio channel for natural language communication, wherein the first signal indicates VA communication;
receiving, by the first VA, a second signal embedded within an inbound portion of the bi-directional audio channel for natural language communication, wherein the second signal indicates VA communication and is generated by a second VA based at least in part on reception, by the second VA, of the first signal; and
based at least in part on the receiving of the second signal: embedding within the outbound portion of the bi-directional audio channel, by the first VA, one or more non-natural-language messages to communicate with the second VA in a manner other than natural language audio.

2. The method of claim 1, wherein the one or more non-natural-language messages to communicate with the second VA comprises binary code embedded in the audio channel.

3. The method of claim 1, wherein the one or more non-natural-language messages to communicate with the second VA comprises text-based communication transmitted encrypted via the audio channel.

4. The method of claim 1, wherein the one or more non-natural-language messages to communicate with the second VA comprises out of-band packet transmission, wherein the first VA and the second VA generate packets based at least in part on VA internal data.

5. The method of claim 1, wherein the one or more non-natural-language messages to communicate with the second VA comprises compressed data transmissions in a sub-band of an audio signal range of the audio channel.

6. The method of claim 1, further comprising:
detecting an absence of a bot communication signal; and
based at least in part on the detecting the absence of the bot communication signal, switching away in real time from the one or more non-natural-language messages to communicate with the second VA to voice communication via the audio channel directly intelligible to a human.

7. The method of claim 1, further comprising:
detecting that a human is communicating via voice communication via the audio channel; and
based at least in part on the detecting that the human is communicating via voice communication, switching away in real time from the one or more non-natural-language messages to communicate with the second VA to voice communication directly intelligible by the human.

8. The method of claim 1, wherein the first signal and the second signal are human imperceptible.

9. The method of claim 1, wherein the first signal is embedded by altering a phase of an audio signal segment to encode binary code, wherein the binary code represents the first signal.

10. The method of claim 1, wherein the first signal is embedded as a predefined sequence of low-amplitude, wide-band signals representing binary code that is introduced into a spectrum of the audio channel transmitted, wherein the binary code represents the first signal, and at detection the predefined sequence of low-amplitude, wide-band signals is known in advance.

11. The method of claim 1, wherein the first signal is embedded by transmitting low amplitude and delayed binary code, wherein the binary code represents the first signal, such that a delay in the transmitting is modulated to encode the binary code.

12. The method of claim 1, wherein the first signal is embedded by quantizing samples of audio code being transmitted such that quantization intervals correspond to binary code that represents the first signal, wherein the quantization intervals are selected according to predefined rules, and at detection the predefined rules used to select the quantization intervals are known in advance.

13. The method of claim 1, wherein the first signal is embedded by embedding binary code representing the first signal into predefined frequency domain components of the audio channel.

14-28. (canceled)

29. A system comprising:
a memory configured to store a first signal; and
control circuitry of a first virtual assistant (VA) configured to:
embed a first signal, retrieved from the memory, within an outbound portion of a bi-directional audio channel for natural language communication, wherein the first signal, indicates VA communication;
receive a second signal embedded within an inbound portion of the bi-directional audio channel for natural language communication, wherein the second signal indicates VA communication and is generated by a second VA based at least in part on reception, by the second VA, of the first signal; and
based at least in part on the receiving of the second signal: embed within the outbound portion of the bi-directional audio channel one or more non-natural-language messages to communicate with the second VA in a manner other than natural language audio.

30. The system of claim 29, wherein the one or more non-natural-language messages to communicate with the second VA comprises binary code embedded in the audio channel.

31. The system of claim 29, wherein the one or more non-natural-language messages to communicate with the second VA comprises text-based communication transmitted encrypted via the audio channel.

32. The system of claim 29, wherein the one or more non-natural-language messages to communicate with the second VA comprises out of-band packet transmission, wherein the first VA and the second VA generate packets based at least in part on VA internal data.

33. The system of claim 29, wherein the one or more non-natural-language messages to communicate with the second VA comprises compressed data transmissions in a sub-band of an audio signal range of the audio channel.

34. The system of claim 29, wherein the system is configured to:
detect an absence of a bot communication signal; and
based at least in part on the detecting the absence of the bot communication signal, switch away in real time from the one or more non-natural-language messages to communicate with the second VA to voice communication via the audio channel directly intelligible to a human.

35. The system of claim 29, wherein the system is configured to:
detect that a human is communicating via voice communication via the audio channel; and
based at least in part on the detecting that the human is communicating via voice communication, switch away in real time from the one or more non-natural-language messages to communicate with the second VA to voice communication directly intelligible by the human.

36-140. (canceled)
